(19) United States
(12) Patent Application Publication
(10) Pub. No.: US 2011/0288860 A1
(43) Pub. Date: Nov. 24, 2011

(54) SYSTEMS, METHODS, APPARATUS, AND COMPUTER-READABLE MEDIA FOR PROCESSING OF SPEECH SIGNALS USING HEAD-MOUNTED MICROPHONE PAIR

(75) Inventors: Andre Gustavo Pucci Schevciw, SAN DIEGO, CA (US); Erik Visser, SAN DIEGO, CA (US); Dinesh Ramakrishnan, SAN DIEGO, CA (US); Ian Ernan Liu, San Diego, CA (US); Ren Li, SAN DIEGO, CA (US); Brian Momeyer, Carlsbad, CA (US); Hyun Jin Park, SAN DIEGO, CA (US); Louis D. Oliveira, SAN DIEGO, CA (US)

(73) Assignee: QUALCOMM INCORPORATED, San Diego, CA (US)

(21) Appl. No.: 13/111,627

(22) Filed: May 19, 2011

Related U.S. Application Data
(60) Provisional application No. 61/346,841, filed on May 20, 2010.
(60) Provisional application No. 61/356,539, filed on Jun. 18, 2010.

(51) Int. Cl. G10L 15/20

(52) U.S. Cl. 704/233; 704/E15.039

(57) ABSTRACT

A noise cancelling headset for voice communications contains a microphone at each of the user's ears and a voice microphone. The headset shares the use of the ear microphones for improving signal-to-noise ratio on both the transmit path and the receive path.

### CLAIM OF PRIORITY UNDER 35 U.S.C. §119

The present Application for Patent claims priority to Provisional Application No. 61/346,841, entitled “Multi-Microphone Configurations in Noise Reduction/Cancellation and Speech Enhancement Systems” filed May 20, 2010, and Provisional Application No. 61/356,539, entitled “Noise Cancelling Headset with Multiple Microphone Array Configurations,” filed Jun. 18, 2010, and assigned to the assignee hereof.

### BACKGROUND

1. Field

This disclosure relates to processing of speech signals.

2. Background

Many activities that were previously performed in quiet office or home environments are being performed today in acoustically variable situations like a car, a street, or a café. For example, a person may desire to communicate with another person using a voice communication channel. The channel may be provided, for example, by a mobile wireless handset or headset, a walkie-talkie, a two-way radio, a car-kit, or another communications device. Consequently, a substantial amount of voice communication is taking place using mobile devices (e.g., smartphones, handsets, and/or headsets) in environments where users are surrounded by other people, with the kind of noise content that is typically encountered where people tend to gather. Such noise tends to distract or annoy a user at the far end of a telephone conversation. Moreover, many standard automated business transactions (e.g., account balance or stock quote checks) employ voice recognition based data inquiry, and the accuracy of these systems may be significantly impeded by interfering noise.

For applications in which communication occurs in noisy environments, it may be desirable to separate a desired speech signal from background noise. Noise may be defined as the combination of all signals interfering with or otherwise degrading the desired signal. Background noise may include numerous noise signals generated within the acoustic environment, such as background conversations of other people, as well as reflections and reverberation generated from the desired signal and/or any of the other signals. Unless the desired speech signal is separated from the background noise, it may be difficult to make reliable and efficient use of it. In one particular example, a speech signal is generated in a noisy environment, and speech processing methods are used to separate the speech signal from the environmental noise.

Noise encountered in a mobile environment may include a variety of different components, such as competing talkers, music, babble, street noise, and/or airport noise. As the signature of such noise is typically nonstationary and close to the user's own frequency signature, the noise may be hard to suppress using traditional single microphone or fixed beamforming type methods. Single microphone noise reduction techniques typically suppress only stationary noises and often introduce significant degradation of the desired speech while providing noise suppression. However, multiple-microphone-based advanced signal processing techniques are typically capable of providing superior voice quality with substantial noise reduction and may be desirable for supporting the use of mobile devices for voice communications in noisy environments.

Voice communication using headsets can be affected by the presence of environmental noise at the near-end. The noise can reduce the signal-to-noise ratio (SNR) of the signal being transmitted to the far-end, as well as the signal being received from the far-end, detracting from intelligibility and reducing network capacity and terminal battery life.

### SUMMARY

A method of signal processing according to a general configuration includes producing a voice activity detection signal that is based on a relation between a first audio signal and a second audio signal; and applying the voice activity detection signal to a signal that is based on a third audio signal to produce a speech signal. In this method, the first audio signal is based on a signal produced (A) by a first microphone that is located at a lateral side of a user's head and (B) in response to a voice of the user, and the second audio signal is based on a signal produced, in response to the voice of the user, by a second microphone that is located at the other lateral side of the user's head. In this method, the third audio signal is based on a signal produced, in response to the voice of the user, by a third microphone that is different from the first and second microphones, and the third microphone is located in a coronal plane of the user's head that is closer to a central exit point of the user's voice than either of the first and second microphones. Computer-readable storage medium having tangible features that cause a machine reading the features to perform such a method are also disclosed.

An apparatus for signal processing according to a general configuration includes means for producing a voice activity detection signal that is based on a relation between a first audio signal and a second audio signal; and means for applying the voice activity detection signal to a signal that is based on a third audio signal to produce a speech signal. In this apparatus, the first audio signal is based on a signal produced (A) by a first microphone that is located at a lateral side of a user's head and (B) in response to a voice of the user, and the second audio signal is based on a signal produced, in response to the voice of the user, by a second microphone that is located at the other lateral side of the user's head. In this apparatus, the third audio signal is based on a signal produced, in response to the voice of the user, by a third microphone that is different from the first and second microphones, and the third microphone is located in a coronal plane of the user's head that is closer to a central exit point of the user's voice than either of the first and second microphones.

An apparatus for signal processing according to another general configuration includes a first microphone configured to be located during a use of the apparatus at a lateral side of a user's head, a second microphone configured to be located during the use of the apparatus at the other lateral side of the user's head, and a third microphone configured to be located during the use of the apparatus in a coronal plane of the user's head that is closer to a central exit point of a voice of the user than either of the first and second microphones. This apparatus also includes a voice activity detector configured to produce a voice activity detection signal that is based on a relation between a first audio signal and a second audio signal, and a speech estimator configured to apply the voice activity detection signal to a signal that is based on a third audio signal to produce a speech estimate. In this apparatus, the first audio signal is based on a signal produced, in response to the voice of the user, by the first microphone during the use of the apparatus; the second audio signal is based on a signal produced, in response to the voice of the user, by the second microphone during the use of the apparatus; and the third audio signal is based on a signal produced, in response to the voice of the user, by the third microphone during the use of the apparatus.

### BRIEF DESCRIPTION OF THE DRAWINGS

FIG. 1A shows a block diagram of an apparatus A100 according to a general configuration.

FIG. 1B shows a block diagram of an implementation A of audio preprocessing stage A.

FIG. 2A shows a front view of noise reference microphones ML10 and MR10 worn on respective ears of a Head and Torso Simulator (HATS).

FIG. 2B shows a left side view of noise reference microphone ML10 worn on the left ear of the HATS.

FIG. 3A shows an example of the orientation of an instance of microphone MC10 at each of several positions during a use of apparatus A100.

FIG. 3B shows a front view of a typical application of a corded implementation of apparatus A100 coupled to a portable media player D400.

FIG. 4A shows a block diagram of an implementation A110 of apparatus A100.

FIG. 4B shows a block diagram of an implementation SE20 of speech estimator SE10.

FIG. 4C shows a block diagram of an implementation SE22 of speech estimator SE20.

FIG. 5A shows a block diagram of an implementation SE30 of speech estimator SE22.

FIG. 5B shows a block diagram of an implementation A130 of apparatus A100.

FIG. 6A shows a block diagram of an implementation A120 of apparatus A100.

FIG. 6B shows a block diagram of speech estimator SE40.

FIG. 7A shows a block diagram of an implementation A140 of apparatus A100.

FIG. 7B shows a front view of an earbud EB10.

FIG. 7C shows a front view of an implementation EB12 of earbud EB10.

FIG. 8A shows a block diagram of an implementation A150 of apparatus A100.

FIG. 8B shows instances of earbud EB10 and voice microphone MC10 in a corded implementation of apparatus A100.

FIG. 9A shows a block diagram of speech estimator SE50.

FIG. 9B shows a side view of an instance of earbud EB10.

FIG. 9C shows an example of a TRRS plug.

FIG. 9D shows an example in which hook switch SW10 is integrated into cord CD 10.

FIG. 9E shows an example of a connector that includes plug P10 and a coaxial plug P20.

FIG. 10A shows a block diagram of an implementation A200 of apparatus A100.

FIG. 10B shows a block diagram of an implementation AP22 of audio preprocessing stage AP12.

FIG. 11A shows a cross-sectional view of an earcup EC10.

FIG. 11B shows a cross-sectional view of an implementation EC20 of earcup EC10.

FIG. 11C shows a cross-section of an implementation EC30 of earcup EC20.

FIG. 12 shows a block diagram of an implementation A210 of apparatus A100.

FIG. 13A shows a block diagram of a communications device D20 that includes an implementation of apparatus A100.

FIGS. 13B and 13C show additional candidate locations for noise reference microphones ML10, MR10 and error microphone ME10.

FIGS. 14A to 14D show various views of a headset D100 that may be included within device D20.

FIG. 15 shows a top view of an example of device D100 in use.

FIGS. 16A-E show additional examples of devices that may be used within an implementation of apparatus A100 as described herein.

FIG. 17A shows a flowchart of a method M100 according to a general configuration.

FIG. 17B shows a flowchart of an implementation M110 of method M100.

FIG. 17C shows a flowchart of an implementation M120 of method M100.

FIG. 17D shows a flowchart of an implementation M130 of method M100.

FIG. 18A shows a flowchart of an implementation M140 of method M100.

FIG. 18B shows a flowchart of an implementation M150 of method M100.

FIG. 18C shows a flowchart of an implementation M200 of method M100.

FIG. 19A shows a block diagram of an apparatus MF100 according to a general configuration.

FIG. 19B shows a block diagram of an implementation MF140 of apparatus MF100.

FIG. 19C shows a block diagram of an implementation MF200 of apparatus MF100.

FIG. 20A shows a block diagram of an implementation A160 of apparatus A100.

FIG. 20B shows a block diagram of an arrangement of speech estimator SE50.

FIG. 21A shows a block diagram of an implementation A170 of apparatus A100.

FIG. 21B shows a block diagram of an implementation SE42 of speech estimator SE40.

### DETAILED DESCRIPTION

Active noise cancellation (ANC, also called active noise reduction) is a technology that actively reduces ambient acoustic noise by generating a waveform that is an inverse form of the noise wave (e.g., having the same level and an inverted phase), also called an “antiphase” or “anti-noise” waveform. An ANC system generally uses one or more microphones to pick up an external noise reference signal, generates an anti-noise waveform from the noise reference signal, and reproduces the anti-noise waveform through one or more loudspeakers. This anti-noise waveform interferes destructively with the original noise wave to reduce the level of the noise that reaches the ear of the user.

Active noise cancellation techniques may be applied to sound reproduction devices, such as headphones, and personal communications devices, such as cellular telephones, to reduce acoustic noise from the surrounding environment. In such applications, the use of an ANC technique may reduce the level of background noise that reaches the ear (e.g., by up to twenty decibels) while delivering useful sound signals, such as music and far-end voices.

A noise-cancelling headset includes a pair of noise reference microphones worn on a user's head and a third microphone that is arranged to receive an acoustic voice signal from the user. Systems, methods, apparatus, and computer-readable media are described for using signals from the head-mounted pair to support automatic cancellation of noise at the user's ears and to generate a voice activity detection signal that is applied to a signal from the third microphone. Such a headset may be used, for example, to simultaneously improve both near-end SNR and far-end SNR while minimizing the number of microphones for noise detection.

Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, smoothing, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Unless expressly limited by its context, the term “selecting” is used to indicate any of its ordinary meanings, such as identifying, indicating, applying, and/or using at least one, and fewer than all, of a set of two or more. Where the term “comprising” is used in the present description and claims, it does not exclude other elements or operations. The term “based on” (as in “A is based on B”) is used to indicate any of its ordinary meanings, including the cases (i) “derived from” (e.g., “B is a precursor of A”), (ii) “based on at least” (e.g., “A is based on at least B”) and, if appropriate in the particular context, (iii) “equal to” (e.g., “A is equal to B”). Similarly, the term “in response to” is used to indicate any of its ordinary meanings, including “in response to at least.”

References to a “location” of a microphone of a multi-microphone audio sensing device indicate the location of the center of an acoustically sensitive face of the microphone, unless otherwise indicated by the context. References to a “direction” or “orientation” of a microphone of a multi-microphone audio sensing device indicate the direction normal to an acoustically sensitive plane of the microphone, unless otherwise indicated by the context. The term “channel” is used at times to indicate a signal path and at other times to indicate a signal carried by such a path, according to the particular context. Unless otherwise indicated, the term “series” is used to indicate a sequence of two or more items. The term “logarithm” is used to indicate the base-ten logarithm, although extensions of such an operation to other bases are within the scope of this disclosure. The term “frequency component” is used to indicate one among a set of frequencies or frequency bands of a signal, such as a sample of a frequency domain representation of the signal (e.g., as produced by a fast Fourier transform) or a subband of the signal (e.g., a Bark scale or mel scale subband).

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Unless expressly limited by its context, the term “system” is used herein to indicate any of its ordinary meanings, including “a group of elements that interact to serve a common purpose.” Any incorporation by reference of a portion of a document shall also be understood to incorporate definitions of terms or variables that are referenced within the portion, where such definitions appear elsewhere in the document, as well as any figures referenced in the incorporated portion.

The terms “coder,” “codec,” and “coding system” are used interchangeably to denote a system that includes at least one encoder configured to receive and encode frames of an audio signal (possibly after one or more pre-processing operations, such as a perceptual weighting and/or other filtering operation) and a corresponding decoder configured to produce decoded representations of the frames. Such an encoder and decoder are typically deployed at opposite terminals of a communications link. In order to support a full-duplex communication, instances of both of the encoder and the decoder are typically deployed at each end of such a link.

In this description, the term “sensed audio signal” denotes a signal that is received via one or more microphones, and the term “reproduced audio signal” denotes a signal that is reproduced from information that is retrieved from storage and/or received via a wired or wireless connection to another device. An audio reproduction device, such as a communications or playback device, may be configured to output the reproduced audio signal to one or more loudspeakers of the device. Alternatively, such a device may be configured to output the reproduced audio signal to an earpiece, other headset, or external loudspeaker that is coupled to the device via a wire or wirelessly. With reference to transceiver applications for voice communications, such as telephony, the sensed audio signal is the near-end signal to be transmitted by the transceiver, and the reproduced audio signal is the far-end signal received by the transceiver (e.g., via a wireless communications link). With reference to mobile audio reproduction applications, such as playback of recorded music, video, or speech (e.g., MP3-encoded music files, movies, video clips, audiobooks, podcasts) or streaming of such content, the reproduced audio signal is the audio signal being played back or streamed.

A headset for use with a cellular telephone handset (e.g., a smartphone) typically contains a loudspeaker for reproducing the far-end audio signal at one of the user's ears and a primary microphone for receiving the user's voice. The loudspeaker is typically worn at the user's ear, and the microphone is arranged within the headset to be disposed during use to receive the user's voice with an acceptably high SNR. The microphone is typically located, for example, within a housing worn at the user's ear, on a boom or other protrusion that extends from such a housing toward the user's mouth, or on a cord that carries audio signals to and from the cellular telephone. Communication of audio information (and possibly control information, such as telephone hook status) between the headset and the handset may be performed over a link that is wired or wireless.

The headset may also include one or more additional secondary microphones at the user's ear, which may be used for improving the SNR in the primary microphone signal. Such a headset does not typically include or use a secondary microphone at the user's other ear for such purpose.

A stereo set of headphones or ear buds may be used with a portable media player for playing reproduced stereo media content. Such a device includes a loudspeaker worn at the user's left ear and a loudspeaker worn in the same fashion at the user's right ear. Such a device may also include, at each of the user's ears, a respective one of a pair of noise reference microphones that are disposed to produce environmental noise signals to support an ANC function. The environmental noise signals produced by the noise reference microphones are not typically used to support processing of the user's voice.

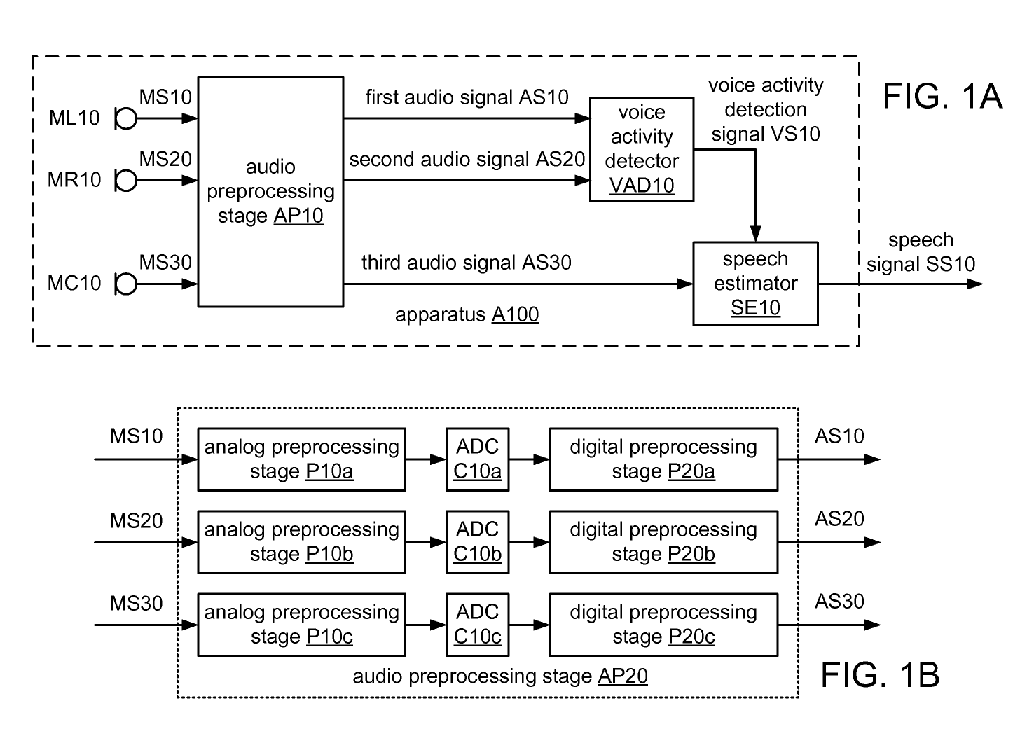

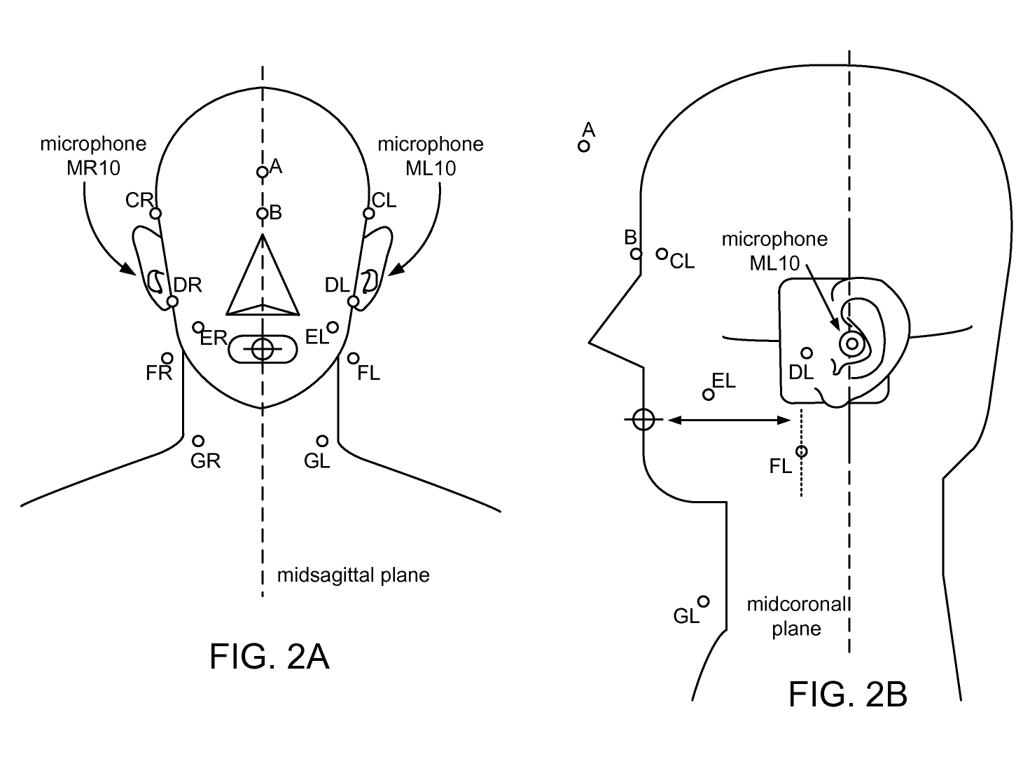

FIG. 1A shows a block diagram of an apparatus A100 according to a general configuration. Apparatus A100 includes a first noise reference microphone ML10 that is worn on the left side of the user's head to receive acoustic environmental noise and is configured to produce a first microphone signal MS10, a second noise reference microphone MR10 that is worn on the right side of the user's head to receive acoustic environmental noise and is configured to produce a second microphone signal MS20, and a voice microphone MC10 that is worn by the user and is configured to produce a third microphone signal MS30. FIG. 2A shows a front view of a Head and Torso Simulator or “HATS” (Bruel and Kjaer, DK) in which noise reference microphones ML10 and MR10 are worn on respective ears of the HATS. FIG. 2B shows a left side view of the HATS in which noise reference microphone ML10 is worn on the left ear of the HATS.

Each of the microphones ML10, MR10, and MC10 may have a response that is omnidirectional, bidirectional, or unidirectional (e.g., cardioid). The various types of microphones that may be used for each of the microphones ML10, MR10, and MC10 include (without limitation) piezoelectric microphones, dynamic microphones, and electret microphones.

It may be expected that while noise reference microphones ML10 and MR10 may pick up energy of the user's voice, the SNR of the user's voice in microphone signals MS10 and MS20 will be too low to be useful for voice transmission. Nevertheless, techniques described herein use this voice information to improve one or more characteristics (e.g., SNR) of a speech signal based on information from third microphone signal MS30.

Microphone MC10 is arranged within apparatus A100 such that during a use of apparatus A100, the SNR of the user's voice in microphone signal MS30 is greater than the SNR of the user's voice in either of microphone signals MS10 and MS20. Alternatively or additionally, voice microphone MC10 is arranged during use to be oriented more directly toward the central exit point of the user's voice, to be closer to the central exit point, and/or to lie in a coronal plane that is closer to the central exit point, than either of noise reference microphones ML10 and MR10. The central exit point of the user's voice is indicated by the crosshair in FIGS. 2A and 2B and is defined as the location in the midsagittal plane of the user's head at which the external surfaces of the user's upper and lower lips meet during speech. The distance between the midcoronal plane and the central exit point is typically in a range of from seven, eight, or nine to 10, 11, 12, 13, or 14 centimeters (e.g., 80-130 mm) (It is assumed herein that distances between a point and a plane are measured along a line that is orthogonal to the plane.) During use of apparatus A100, voice microphone MC10 is typically located within thirty centimeters of the central exit point.

Several different examples of positions for voice microphone MC10 during a use of apparatus A100 are shown by labeled circles in FIG. 2A. In position A, voice microphone MC10 is mounted in a visor of a cap or helmet. In position B, voice microphone MC10 is mounted in the bridge of a pair of eyeglasses, goggles, safety glasses, or other eyewear. In position CL or CR, voice microphone MC10 is mounted in a left or right temple of a pair of eyeglasses, goggles, safety glasses, or other eyewear. In position DL or DR, voice microphone MC10 is mounted in the forward portion of a headset housing that includes a corresponding one of microphones ML10 and MR10. In position EL or ER, voice microphone MC10 is mounted on a boom that extends toward the user's mouth from a hook worn over the user's ear. In position FL, FR, GL, or GR, voice microphone MC10 is mounted on a cord that electrically connects voice microphone MC10, and a corresponding one of noise reference microphones ML10 and MR10, to the communications device.

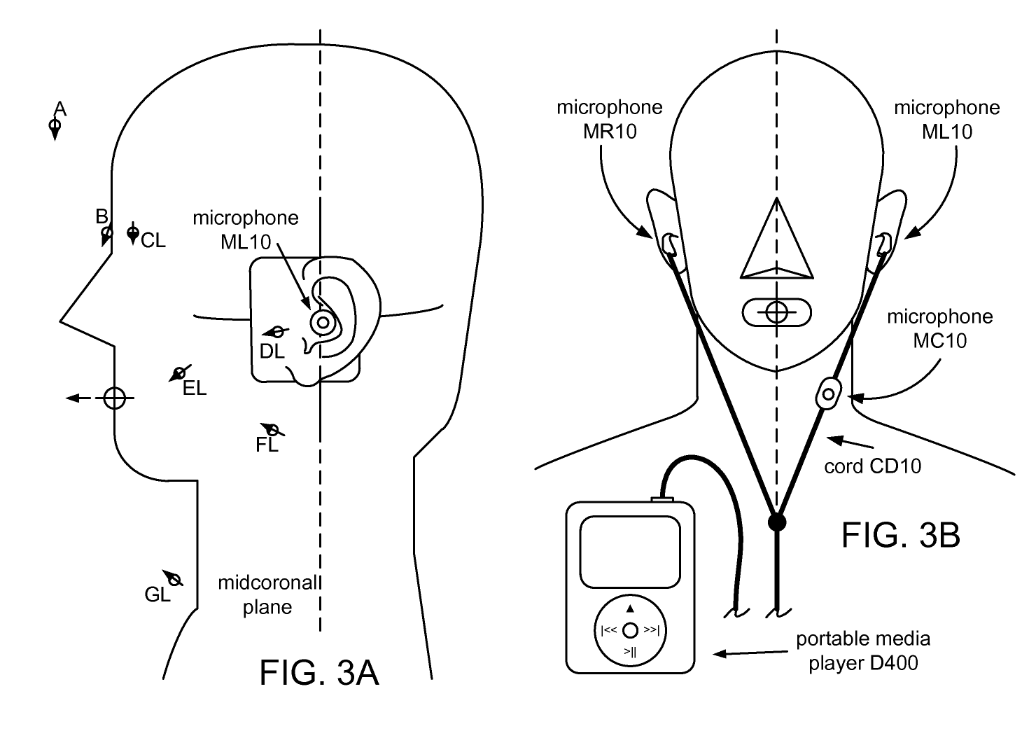

The side view of FIG. 2B illustrates that all of the positions A, B, CL, DL, EL, FL, and GL are in coronal planes (i.e., planes parallel to the midcoronal plane as shown) that are closer to the central exit point than noise reference microphone ML10 is (e.g., as illustrated with respect to position FL). The side view of FIG. 3A shows an example of the orientation of an instance of microphone MC10 at each of these positions and illustrates that each of the instances at positions A, B, DL, EL, FL, and GL is oriented more directly toward the central exit point than microphone ML10 (which is oriented normal to the plane of the figure).

FIG. 3B shows a front view of a typical application of a corded implementation of apparatus A100 coupled to a portable media player D400 via cord CD10. Such a device may be configured for playback of compressed audio or audiovisual information, such as a file or stream encoded according to a standard compression format (e.g., Moving Pictures Experts Group (MPEG)-1 Audio Layer 3 (MP3), MPEG-4 Part 14 (MP4), a version of Windows Media Audio/Video (WMA/WMV) (Microsoft Corp., Redmond, Wash.), Advanced Audio Coding (AAC), International Telecommunication Union (ITU)-T H.264, or the like).

Apparatus A100 includes an audio preprocessing stage that performs one or more preprocessing operations on each of the microphone signals MS10, MS20, and MS30 to produce a corresponding one of a first audio signal AS10, a second audio signal AS20, and a third audio signal AS30. Such preprocessing operations may include (without limitation) impedance matching, analog-to-digital conversion, gain control, and/or filtering in the analog and/or digital domains.

FIG. 1B shows a block diagram of an implementation AP20 of audio preprocessing stage AP10 that includes analog preprocessing stages P10a, P10b, and P10c. In one example, stages P10a, P10b, and P10c are each configured to perform a highpass filtering operation (e.g., with a cutoff frequency of 50, 100, or 200 Hz) on the corresponding microphone signal. Typically, stages P10a and P10b will be configured to perform the same functions on first audio signal AS10 and second audio signal AS20, respectively.

It may be desirable for audio preprocessing stage AP10 to produce the multichannel signal as a digital signal, that is to say, as a sequence of samples. Audio preprocessing stage AP20, for example, includes analog-to-digital converters (ADCs) C10a, C10b, and C10c that are each arranged to sample the corresponding analog signal. Typical sampling rates for acoustic applications include 8 kHz, 12 kHz, 16 kHz, and other frequencies in the range of from about 8 to about 16 kHz, although sampling rates as high as about 44.1, 48, or 192 kHz may also be used. Typically, converters C10a and C10b will be configured to sample first audio signal AS10 and second audio signal AS20, respectively, at the same rate, while converter C10c may be configured to sample third audio signal C10c at the same rate or at a different rate (e.g., at a higher rate).

In this particular example, audio preprocessing stage AP20 also includes digital preprocessing stages P20a, P20b, and P20c that are each configured to perform one or more preprocessing operations (e.g., spectral shaping) on the corresponding digitized channel. Typically, stages P20a and P20b will be configured to perform the same functions on first audio signal AS10 and second audio signal AS20, respectively, while stage P20c may be configured to perform one or more different functions (e.g., spectral shaping, noise reduction, and/or echo cancellation) on third audio signal AS30.

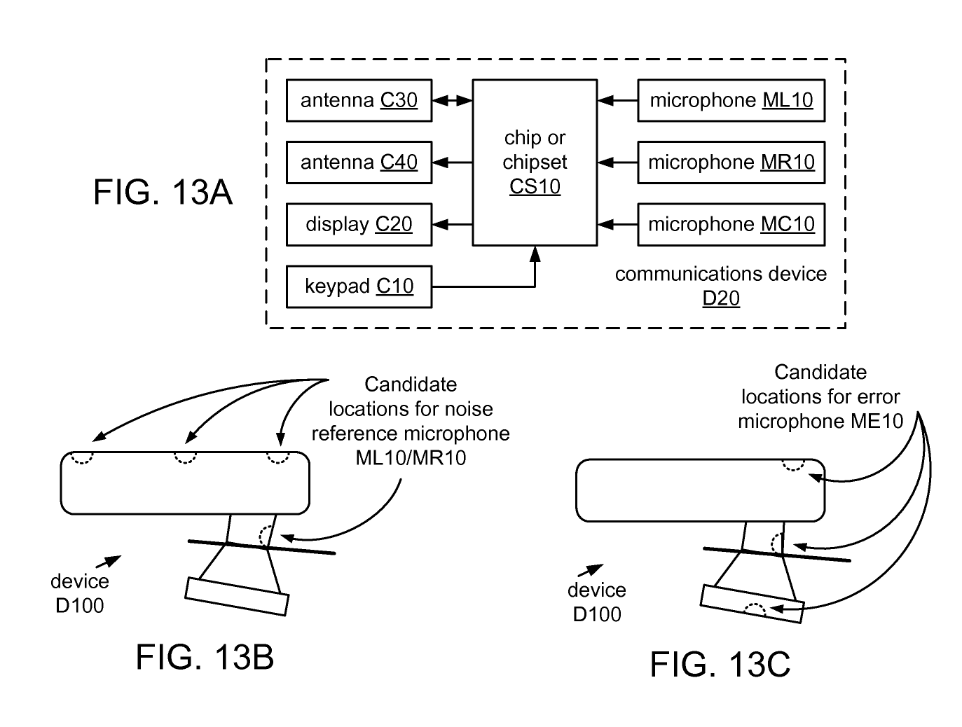

It is specifically noted that first audio signal AS10 and/or second audio signal AS20 may be based on signals from two or more microphones. For example, FIG. 13B shows examples of several locations at which multiple instances of microphone ML10 (and/or MR10) may be located at the corresponding lateral side of the user's head. Additionally or alternatively, third audio signal AS30 may be based on signals from two or more instances of voice microphone MC10 (e.g., a primary microphone disposed at location EL and a secondary microphone disposed at location DL as shown in FIG. 2B). In such cases, audio preprocessing stage AP10 may be configured to mix and/or perform other processing operations on the multiple microphone signals to produce the corresponding audio signal.

In a speech processing application (e.g., a voice communications application, such as telephony), it may be desirable to perform accurate detection of segments of an audio signal that carry speech information. Such voice activity detection (VAD) may be important, for example, in preserving the speech information. Speech coders are typically configured to allocate more bits to encode segments that are identified as speech than to encode segments that are identified as noise, such that a misidentification of a segment carrying speech information may reduce the quality of that information in the decoded segment. In another example, a noise reduction system may aggressively attenuate low-energy unvoiced speech segments if a voice activity detection stage fails to identify these segments as speech.

A multichannel signal, in which each channel is based on a signal produced by a different microphone, typically contains information regarding source direction and/or proximity that may be used for voice activity detection. Such a multichannel VAD operation may be based on direction of arrival (DOA), for example, by distinguishing segments that contain directional sound arriving from a particular directional range (e.g., the direction of a desired sound source, such as the user's mouth) from segments that contain diffuse sound or directional sound arriving from other directions.

Apparatus A100 includes a voice activity detector VAD10 that is configured to produce a voice activity detection (VAD) signal VS10 based on a relation between information from first audio signal AS10 and information from second audio signal AS20. Voice activity detector VAD10 is typically configured to process each of a series of corresponding segments of audio signals AS10 and AS20 to indicate whether a transition in voice activity state is present in a corresponding segment of audio signal AS30. Typical segment lengths range from about five or ten milliseconds to about forty or fifty milliseconds, and the segments may be overlapping (e.g., with adjacent segments overlapping by 25% or 50%) or nonoverlapping. In one particular example, each of signals AS10, AS20, and AS30 is divided into a series of nonoverlapping segments or “frames”, each frame having a length of ten milliseconds. A segment as processed by voice activity detector VAD10 may also be a segment (i.e., a “subframe”) of a larger segment as processed by a different operation, or vice versa.

In a first example, voice activity detector VAD10 is configured to produce VAD signal VS10 by cross-correlating corresponding segments of first audio signal AS10 and second audio signal AS20 in the time domain. Voice activity detector VAD10 may be configured to calculate the cross-correlation r(d) over a range of delays −d to +d according to an expression such as the following:

$$\begin{matrix}r ( d ) = {\sum }_{i = max ( 1 , d + 1 )}^{min ( N - d , N + d )} x [ i - d ] y [ i ] \\ or & ( 1 ) \\ r ( d ) = \frac{1}{N - 1} {\sum }_{i = max ( 1 , d + 1 )}^{min ( N - d , N + d )} x [ i - d ] y [ i ] ; & ( 2 )\end{matrix}$$

where x denotes first audio signal AS10, y denotes second audio signal AS20, and N denotes the number of samples in each segment.

Instead of using zero-padding as shown above, expressions (1) and (2) may also be configured to treat each segment as circular or to extend into the previous or subsequent segment as appropriate. In any of these cases, voice activity detector VAD10 may be configured to calculate the cross-correlation by normalizing r(d) according to an expression such as the following:

$$\overline{r} ( d ) = \frac{r ( d )}{\sqrt{{\sum }_{i = 1}^{N} {( x [ i ] - {μ}_{x} )}^{2}} \sqrt{{\sum }_{i = 1}^{N} {( y [ i ] - {μ}_{y} )}^{2}}} , \qquad ( 3 )$$

where μₓ denotes the mean of the segment of first audio signal AS10 and μ_{y} denotes the mean of the segment of second audio signal AS20.

It may be desirable to configure voice activity detector VAD10 to calculate the cross-correlation over a limited range around zero delay. For an example in which the sampling rate of the microphone signals is eight kilohertz, it may be desirable for the VAD to cross-correlate the signals over a limited range of plus or minus one, two, three, four, or five samples. In such a case, each sample corresponds to a time difference of 125 microseconds (equivalently, a distance of 4.25 centimeters). For an example in which the sampling rate of the microphone signals is sixteen kilohertz, it may be desirable for the VAD to cross-correlate the signals over a limited range of plus or minus one, two, three, four, or five samples. In such a case, each sample corresponds to a time difference of 62.5 microseconds (equivalently, a distance of 2.125 centimeters).

Additionally or alternatively, it may be desirable to configure voice activity detector VAD10 to calculate the cross-correlation over a desired frequency range. For example, it may be desirable to configure audio preprocessing stage AP10 to provide first audio signal AS10 and second audio signal AS20 as bandpass signals having a range of, for example, from 50 (or 100, 200, or 500) Hz to 500 (or 1000, 1200, 1500, or 2000) Hz. Each of these nineteen particular range examples (excluding the trivial case of from 500 to 500 Hz) is expressly contemplated and hereby disclosed.

In any of the cross-correlation examples above, voice activity detector VAD10 may be configured to produce VAD signal VS10 such that the state of VAD signal VS10 for each segment is based on the corresponding cross-correlation value at zero delay. In one example, voice activity detector VAD10 is configured to produce VAD signal VS10 to have a first state that indicates a presence of voice activity (e.g., high or one) if the zero-delay value is the maximum among the delay values calculated for the segment, and a second state that indicates a lack of voice activity (e.g., low or zero) otherwise. In another example, voice activity detector VAD10 is configured to produce VAD signal VS10 to have the first state if the zero-delay value is above (alternatively, not less than) a threshold value, and the second state otherwise. In such case, the threshold value may be fixed or may be based on a mean sample value for the corresponding segment of third audio signal AS30 and/or on cross-correlation results for the segment at one or more other delays. In a further example, voice activity detector VAD10 is configured to produce VAD signal VS10 to have the first state if the zero-delay value is greater than (alternatively, at least equal to) a specified proportion (e.g., 0.7 or 0.8) of the highest among the corresponding values for delays of +1 sample and −1 sample, and the second state otherwise. Voice activity detector VAD10 may also be configured to combine two or more such results (e.g., using AND and/or OR logic).

Voice activity detector VAD10 may be configured to include an inertial mechanism to delay state changes in signal VS10. One example of such a mechanism is logic that is configured to inhibit detector VAD10 from switching its output from the first state to the second state until the detector continues to detect a lack of voice activity over a hangover period of several consecutive frames (e.g., one, two, three, four, five, eight, ten, twelve, or twenty frames). For example, such hangover logic may be configured to cause detector VAD10 to continue to identify segments as speech for some period after the most recent detection of voice activity.

In a second example, voice activity detector VAD10 is configured to produce VAD signal VS10 based on a difference between levels (also called gains) of first audio signal AS10 and second audio signal AS20 over the segment in the time domain. Such an implementation of voice activity detector VAD10 may be configured, for example, to indicate voice detection when the level of one or both signals is above a threshold value (indicating that the signal is arriving from a source that is close to the microphone) and the levels of the two signals are substantially equal (indicating that the signal is arriving from a location between the two microphones). In this case, the term “substantially equal” indicates within five, ten, fifteen, twenty, or twenty-five percent of the level of the lesser signal. Examples of level measures for a segment include total magnitude (e.g., sum of absolute values of sample values), average magnitude (e.g., per sample), RMS amplitude, median magnitude, peak magnitude, total energy (e.g., sum of squares of sample values), and average energy (e.g., per sample). In order to obtain accurate results with a level-difference technique, it may be desirable for the responses of the two microphone channels to be calibrated relative to each other.

Voice activity detector VAD10 may be configured to use one or more of the time-domain techniques described above to compute VAD signal VS10 at relatively little computational expense. In a further implementation, voice activity detector VAD10 is configured to compute such a value of VAD signal VS10 (e.g., based on a cross-correlation or level difference) for each of a plurality of subbands of each segment. In this case, voice activity detector VAD10 may be arranged to obtain the time-domain subband signals from a bank of subband filters that is configured according to a uniform subband division or a nonuniform subband division (e.g., according to a Bark or Mel scale).

In a further example, voice activity detector VAD10 is configured to produce VAD signal VS10 based on differences between first audio signal AS10 and second audio signal AS20 in the frequency domain. One class of frequency-domain VAD operations is based on the phase difference, for each frequency component of the segment in a desired frequency range, between the frequency component in each of two channels of the multichannel signal. Such a VAD operation may be configured to indicate voice detection when the relation between phase difference and frequency is consistent (i.e., when the correlation of phase difference and frequency is linear) over a wide frequency range, such as 500-2000 Hz. Such a phase-based VAD operation is described in more detail below. Additionally or alternatively, voice activity detector VAD10 may be configured to produce VAD signal VS10 based on a difference between levels of first audio signal AS10 and second audio signal AS20 over the segment in the frequency domain (e.g., over one or more particular frequency ranges). Additionally or alternatively, voice activity detector VAD10 may be configured to produce VAD signal VS10 based on a cross-correlation between first audio signal AS10 and second audio signal AS20 over the segment in the frequency domain (e.g., over one or more particular frequency ranges). It may be desirable to configure a frequency-domain voice activity detector (e.g., a phase-, level-, or cross-correlation-based detector as described above) to consider only frequency components which correspond to multiples of a current pitch estimate for third audio signal AS30.

Multichannel voice activity detectors that are based on inter-channel gain differences and single-channel (e.g., energy-based) voice activity detectors typically rely on information from a wide frequency range (e.g., a 0-4 kHz, 500-4000 Hz, 0-8 kHz, or 500-8000 Hz range). Multichannel voice activity detectors that are based on direction of arrival (DOA) typically rely on information from a low-frequency range (e.g., a 500-2000 Hz or 500-2500 Hz range). Given that voiced speech usually has significant energy content in these ranges, such detectors may generally be configured to reliably indicate segments of voiced speech. Another VAD strategy that may be combined with those described herein is a multichannel VAD signal based on inter-channel gain difference in a low-frequency range (e.g., below 900 Hz or below 500 Hz). Such a detector may be expected to accurately detect voiced segments with a low rate of false alarms.

Voice activity detector VAD10 may be configured to perform and combine results from more than one of the VAD operations on first audio signal AS10 and second audio signal AS20 described herein to produce VAD signal VS10. Alternatively or additionally, voice activity detector VAD10 may be configured to perform one or more VAD operations on third audio signal AS30 and to combine results from such operations with results from one or more of the VAD operations on first audio signal AS10 and second audio signal AS20 described herein to produce VAD signal VS10.

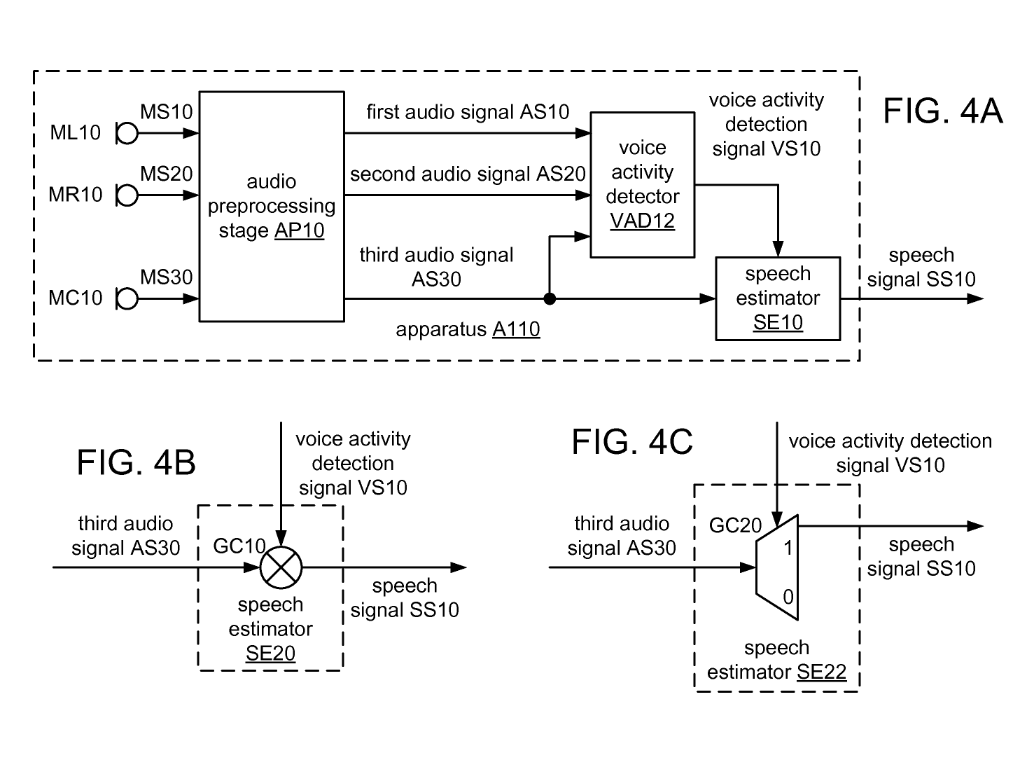

FIG. 4A shows a block diagram of an implementation A110 of apparatus A100 that includes an implementation VAD12 of voice activity detector VAD10. Voice activity detector VAD12 is configured to receive third audio signal AS30 and to produce VAD signal VS10 based also on a result of one or more single-channel VAD operations on signal AS30. Examples of such single-channel VAD operations include techniques that are configured to classify a segment as active (e.g., speech) or inactive (e.g., noise) based on one or more factors such as frame energy, signal-to-noise ratio, periodicity, autocorrelation of speech and/or residual (e.g., linear prediction coding residual), zero crossing rate, and/or first reflection coefficient. Such classification may include comparing a value or magnitude of such a factor to a threshold value and/or comparing the magnitude of a change in such a factor to a threshold value. Alternatively or additionally, such classification may include comparing a value or magnitude of such a factor, such as energy, or the magnitude of a change in such a factor, in one frequency band to a like value in another frequency band. It may be desirable to implement such a VAD technique to perform voice activity detection based on multiple criteria (e.g., energy, zero-crossing rate, etc.) and/or a memory of recent VAD decisions.

One example of a VAD operation whose results may be combined by detector VAD12 with results from more than one of the VAD operations on first audio signal AS10 and second audio signal AS20 described herein includes comparing highband and lowband energies of the segment to respective thresholds, as described, for example, in section 4.7 (pp. 4-48 to 4-55) of the 3GPP2 document C.S0014-D, v3.0, entitled “Enhanced Variable Rate Codec, Speech Service Options 3, 68, 70, and 73 for Wideband Spread Spectrum Digital Systems,” October 2010 (available online at www-dot-3gpp-dot-org). Other examples (e.g., detecting speech onsets and/or offsets, comparing a ratio of frame energy to average energy and/or a ratio of lowband energy to highband energy) are described in U.S. patent application Ser. No. ______, entitled “SYSTEMS, METHODS, AND APPARATUS FOR SPEECH FEATURE DETECTION,” Attorney Docket No. 100839, filed Apr. 20, 2011 (Visser et al.).

An implementation of voice activity detector VAD10 as described herein (e.g., VAD10, VAD12) may be configured to produce VAD signal VS10 as a binary-valued signal or flag (i.e., having two possible states) or as a multi-valued signal (i.e., having more than two possible states). In one example, detector VAD10 or VAD12 is configured to produce a multivalued signal by performing a temporal smoothing operation (e.g., using a first-order IIR filter) on a binary-valued signal.

It may be desirable to configure apparatus A100 to use VAD signal VS10 for noise reduction and/or suppression. In one such example, VAD signal VS10 is applied as a gain control on third audio signal AS30 (e.g., to attenuate noise frequency components and/or segments). In another such example, VAD signal VS10 is applied to calculate (e.g., update) a noise estimate for a noise reduction operation (e.g., using frequency components or segments that have been classified by the VAD operation as noise) on third audio signal AS30 that is based on the updated noise estimate.

Apparatus A100 includes a speech estimator SE10 that is configured to produce a speech signal SS10 from third audio signal SA30 according to VAD signal VS30. FIG. 4B shows a block diagram of an implementation SE20 of speech estimator SE10 that includes a gain control element GC10. Gain control element GC10 is configured to apply a corresponding state of VAD signal VS10 to each segment of third audio signal AS30. In a general example, gain control element GC10 is implemented as a multiplier and each state of VAD signal VS10 has a value in the range of from zero to one.

FIG. 4C shows a block diagram of an implementation SE22 of speech estimator SE20 in which gain control element GC10 is implemented as a selector GC20 (e.g., for a case in which VAD signal VS10 is binary-valued). Gain control element GC20 may be configured to produce speech signal SS10 by passing segments identified by VAD signal VS10 as containing voice and blocking segments identified by VAD signal VS10 as noise only (also called “gating”).

By attenuating or removing segments of third audio signal AS30 that are identified as lacking voice activity, speech estimator SE20 or SE22 may be expected to produce a speech signal SS10 that contains less noise overall than third audio signal AS30. However, it may also be expected that such noise will be present as well in the segments of third audio signal AS30 that contain voice activity, and it may be desirable to configure speech estimator SE10 to perform one or more additional operations to reduce noise within these segments.

The acoustic noise in a typical environment may include babble noise, airport noise, street noise, voices of competing talkers, and/or sounds from interfering sources (e.g., a TV set or radio). Consequently, such noise is typically nonstationary and may have an average spectrum is close to that of the user's own voice. A noise power reference signal as computed according to a single-channel VAD signal (e.g., a VAD signal based only on third audio signal AS30) is usually only an approximate stationary noise estimate. Moreover, such computation generally entails a noise power estimation delay, such that corresponding gain adjustment can only be performed after a significant delay. It may be desirable to obtain a reliable and contemporaneous estimate of the environmental noise.

An improved single-channel noise reference (also called a “quasi-single-channel” noise estimate) may be calculated by using VAD signal VS10 to classify components and/or segments of third audio signal AS30. Such a noise estimate may be available more quickly than other approaches, as it does not require a long-term estimate. This single-channel noise reference can also capture nonstationary noise, unlike a long-term-estimate-based approach, which is typically unable to support removal of nonstationary noise. Such a method may provide a fast, accurate, and nonstationary noise reference. Apparatus A100 may be configured to produce the noise estimate by smoothing the current noise segment with the previous state of the noise estimate (e.g., using a first-degree smoother, possibly on each frequency component).

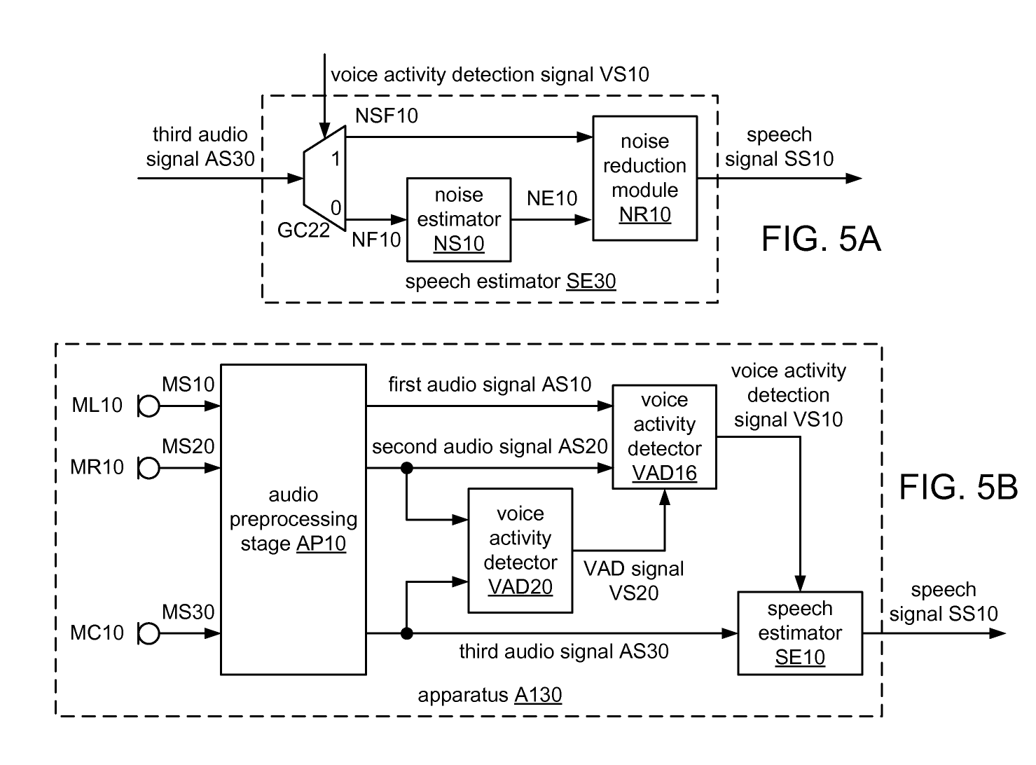

FIG. 5A shows a block diagram of an implementation SE30 of speech estimator SE22 that includes an implementation GC22 of selector GC20. Selector GC22 is configured to separate third audio signal AS30 into a stream of noisy speech segments NSF10 and a stream of noise segments NF10, based on corresponding states of VAD signal VS10. Speech estimator SE30 also includes a noise estimator NS10 that is configured to update a noise estimate NE10 (e.g., a spectral profile of the noise component of third audio signal AS30) based on information from noise segments NF10.

Noise estimator NS10 may be configured to calculate noise estimate NE10 as a time-average of noise segments NF10. Noise estimator NS10 may be configured, for example, to use each noise segment to update the noise estimate. Such updating may be performed in a frequency domain by temporally smoothing the frequency component values. For example, noise estimator NS10 may be configured to use a first-order IIR filter to update the previous value of each component of the noise estimate with the value of the corresponding component of the current noise segment. Such a noise estimate may be expected to provide a more reliable noise reference than one that is based only on VAD information from third audio signal AS30.

Speech estimator SE30 also includes a noise reduction module NR10 that is configured to perform a noise reduction operation on noisy speech segments NSF10 to produce speech signal SS10. In one such example, noise reduction module NR10 is configured to perform a spectral subtraction operation by subtracting noise estimate NE10 from noisy speech frames NSF10 to produce speech signal SS10 in the frequency domain. In another such example, noise reduction module NR10 is configured to use noise estimate NE10 to perform a Wiener filtering operation on noisy speech frames NSF10 to produce speech signal SS10.

Noise reduction module NR10 may be configured to perform the noise reduction operation in the frequency domain and to convert the resulting signal (e.g., via an inverse transform module) to produce speech signal SS10 in the time domain. Further examples of post-processing operations (e.g., residual noise suppression, noise estimate combination) that may be used within noise estimator NS10 and/or noise reduction module NR10 are described in U.S. Pat. Appl. No. 61/406,382 (Shin et al., filed Oct. 25, 2010).

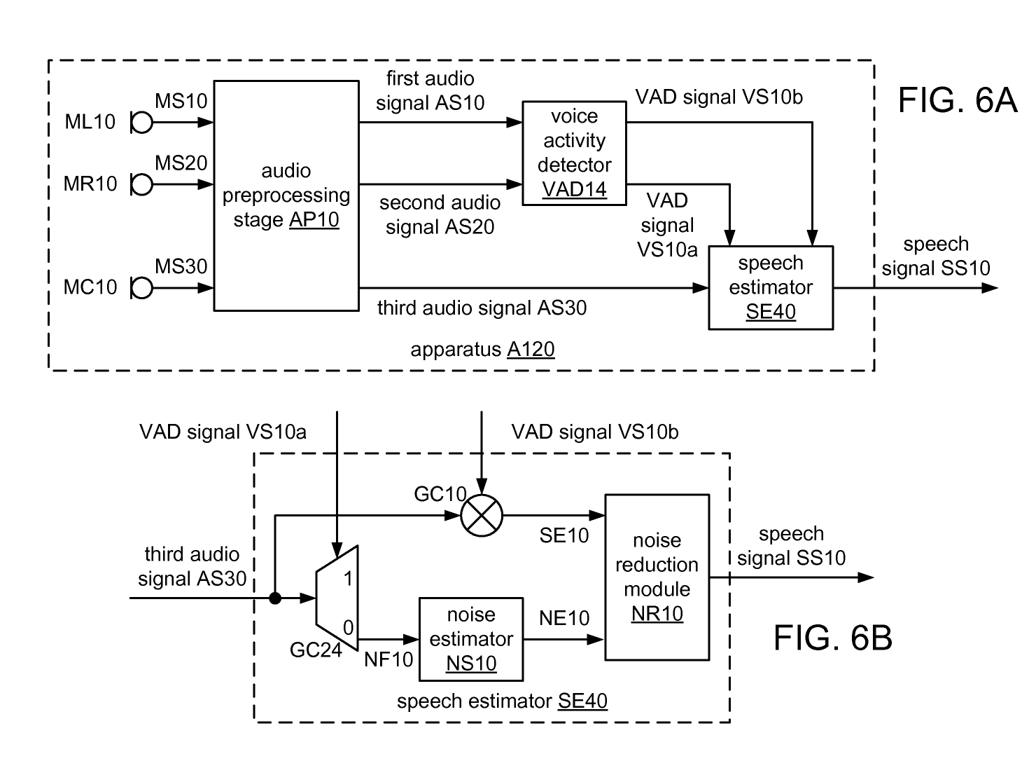

FIG. 6A shows a block diagram of an implementation A120 of apparatus A100 that includes an implementation VAD14 of voice activity detector VAD10 and an implementation SE40 of speech estimator SE10. Voice activity detector VAD14 is configured to produce two versions of VAD signal VS10: a binary-valued signal VS10a as described above, and a multi-valued signal VS10b as described above. In one example, detector VAD14 is configured to produce signal VS10b by performing a temporal smoothing operation (e.g., using a first-order IIR filter), and possibly an inertial operation (e.g., a hangover), on signal VS10a.

FIG. 6B shows a block diagram of speech estimator SE40, which includes an instance of gain control element GC10 that is configured to perform non-binary gain control on third audio signal AS30 according to VAD signal VS10b to produce speech estimate SE10. Speech estimator SE40 also includes an implementation GC24 of selector GC20 that is configured to produce a stream of noise frames NF10 from third audio signal AS30 according to VAD signal VS10a.

As described above, spatial information from the microphone array ML10 and MR10 is used to produce a VAD signal which is applied to enhance voice information from microphone MC10. It may also be desirable to use spatial information from the microphone array MC10 and ML10 (or MC10 and MR10) to enhance voice information from microphone MC10.

In a first example, a VAD signal based on spatial information from the microphone array MC10 and ML10 (or MC10 and MR10) is used to enhance voice information from microphone MC10. FIG. 5B shows a block diagram of such an implementation A130 of apparatus A100. Apparatus A130 includes a second voice activity detector VAD20 that is configured to produce a second VAD signal VS20 based on information from second audio signal AS20 and from third audio signal AS30. Detector VAD20 may be configured to operate in the time domain or in the frequency domain and may be implemented as an instance of any of the multichannel voice activity detectors described herein (e.g., detectors based on inter-channel level differences; detectors based on direction of arrival, including phase-based and cross-correlation-based detectors).

For a case in which a gain-based scheme is used, detector VAD20 may be configured to produce VAD signal VS20 to indicate a presence of voice activity when the ratio of the level of third audio signal AS30 to the level of second audio signal AS20 exceeds (alternatively, is not less than) a threshold value, and a lack of voice activity otherwise. Equivalently, detector VAD20 may be configured to produce VAD signal VS20 to indicate a presence of voice activity when the difference between the logarithm of the level of third audio signal AS30 to the logarithm of the level of second audio signal AS20 exceeds (alternatively, is not less than) a threshold value, and a lack of voice activity otherwise.

For a case in which a DOA-based scheme is used, detector VAD20 may be configured to produce VAD signal VS20 to indicate a presence of voice activity when the DOA of the segment is close to (e.g., within ten, fifteen, twenty, thirty, or forty-five degrees of) the axis of the microphone pair in the direction from microphone MR10 through microphone MC10, and a lack of voice activity otherwise.

Apparatus A130 also includes an implementation VAD16 of voice activity detector VAD10 that is configured to combine VAD signal VS20 (e.g., using AND and/or OR logic) with results from one or more of the VAD operations on first audio signal AS10 and second audio signal AS20 described herein (e.g., a time-domain cross-correlation-based operation), and possibly with results from one or more VAD operations on third audio signal AS30 as described herein, to obtain VAD signal VS10.

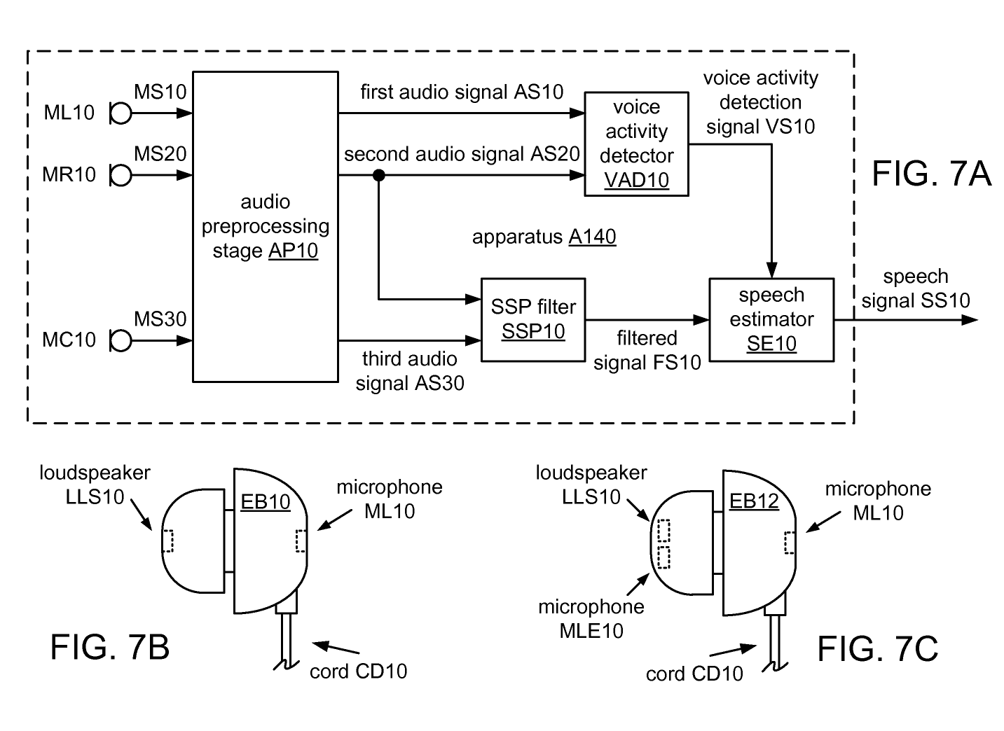

In a second example, spatial information from the microphone array MC10 and ML10 (or MC10 and MR10) is used to enhance voice information from microphone MC10 upstream of speech estimator SE10. FIG. 7A shows a block diagram of such an implementation A140 of apparatus A100. Apparatus A140 includes a spatially selective processing (SSP) filter SSP10 that is configured to perform a SSP operation on second audio signal AS20 and third audio signal AS30 to produce a filtered signal FS10. Examples of such SSP operations include (without limitation) blind source separation, beamforming, null beamforming, and directional masking schemes. Such an operation may be configured, for example, such that a voice-active frame of filtered signal FS10 includes more of the energy of the user's voice (and/or less energy from other directional sources and/or from background noise) than the corresponding frame of third audio signal AS30. In this implementation, speech estimator SE10 is arranged to receive filtered signal FS10 as input in place of third audio signal AS30.

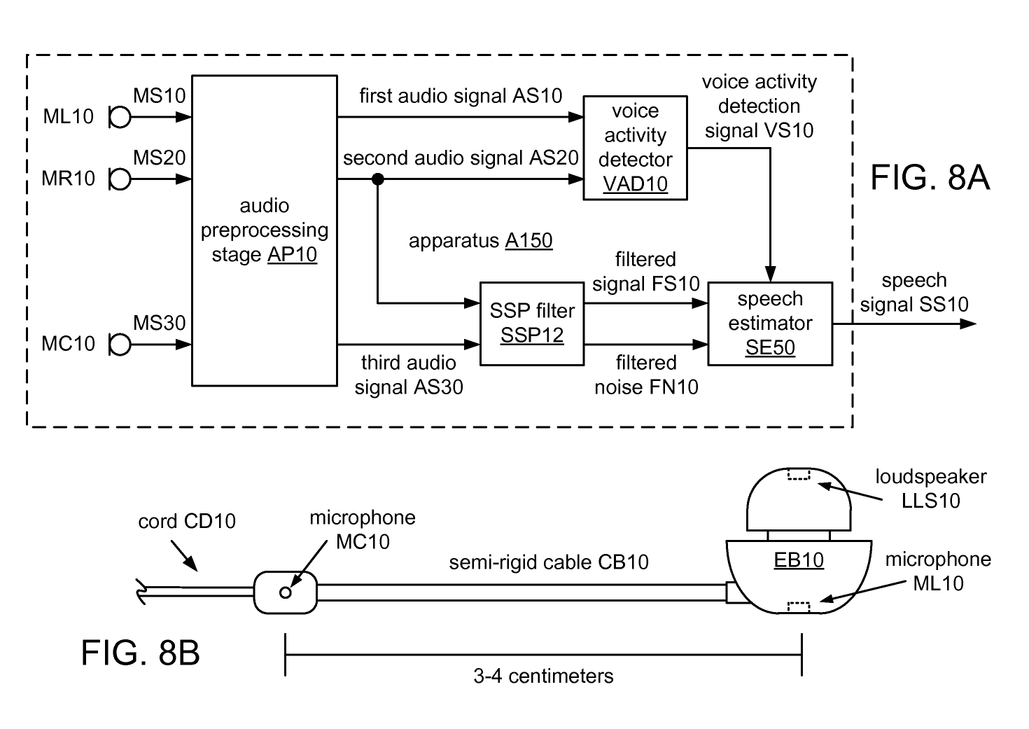

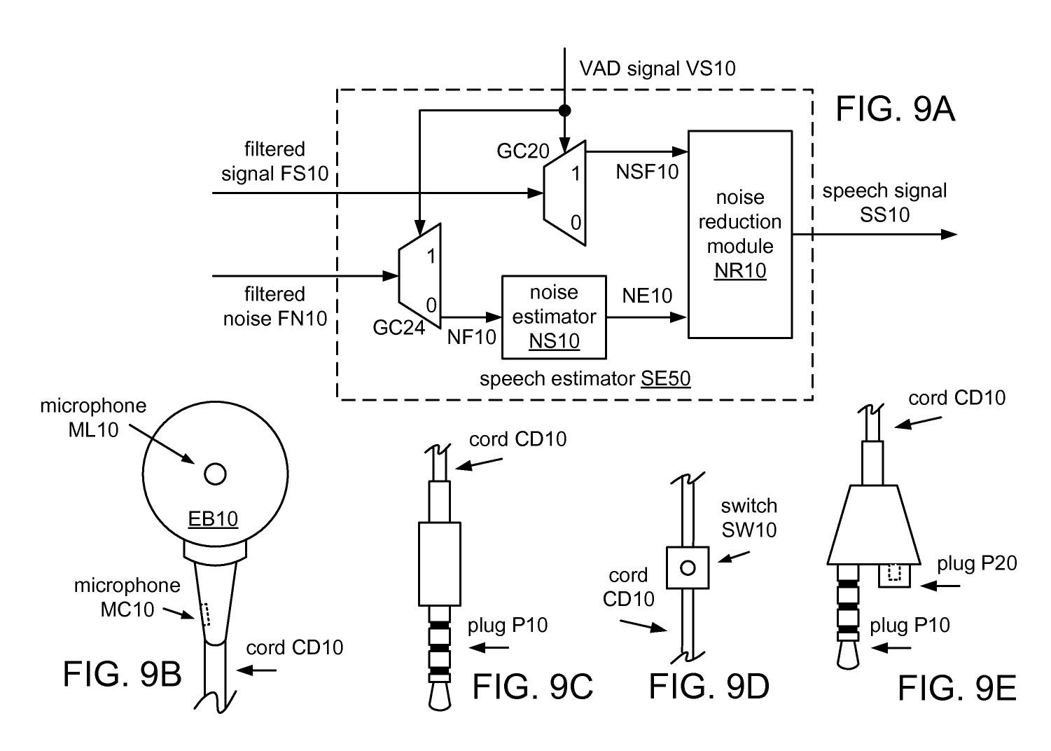

FIG. 8A shows a block diagram of an implementation A150 of apparatus A100 that includes an implementation SSP12 of SSP filter SSP10 that is configured to produce a filtered noise signal FN10. Filter SSP12 may be configured, for example, such that a frame of filtered noise signal FN10 includes more of the energy from directional noise sources and/or from background noise than a corresponding frame of third audio signal AS30. Apparatus A150 also includes an implementation SE50 of speech estimator SE30 that is configured and arranged to receive filtered signal FS10 and filtered noise signal FN10 as inputs. FIG. 9A shows a block diagram of speech estimator SE50, which includes an instance of selector GC20 that is configured to produce a stream of noisy speech frames NSF10 from filtered signal FS10 according to VAD signal VS10. Speech estimator SE50 also includes an instance of selector GC24 that is configured and arranged to produce a stream of noise frames NF10 from filtered noise signal FN30 according to VAD signal VS10.

In one example of a phase-based voice activity detector, a directional masking function is applied at each frequency component to determine whether the phase difference at that frequency corresponds to a direction that is within a desired range, and a coherency measure is calculated according to the results of such masking over the frequency range under test and compared to a threshold to obtain a binary VAD indication. Such an approach may include converting the phase difference at each frequency to a frequency-independent indicator of direction, such as direction of arrival or time difference of arrival (e.g., such that a single directional masking function may be used at all frequencies). Alternatively, such an approach may include applying a different respective masking function to the phase difference observed at each frequency.

In another example of a phase-based voice activity detector, a coherency measure is calculated based on the shape of distribution of the directions of arrival of the individual frequency components in the frequency range under test (e.g., how tightly the individual DOAs are grouped together). In either case, it may be desirable to configure the phase-based voice activity detector to calculate the coherency measure based only on frequencies that are multiples of a current pitch estimate.

For each frequency component to be examined, for example, the phase-based detector may be configured to estimate the phase as the inverse tangent (also called the arctangent) of the ratio of the imaginary term of the corresponding fast Fourier transform (PIT) coefficient to the real term of the PIT coefficient.

It may be desirable to configure a phase-based voice activity detector to determine directional coherence between channels of each pair over a wideband range of frequencies. Such a wideband range may extend, for example, from a low frequency bound of zero, fifty, one hundred, or two hundred Hz to a high frequency bound of three, 3.5, or four kHz (or even higher, such as up to seven or eight kHz or more). However, it may be unnecessary for the detector to calculate phase differences across the entire bandwidth of the signal. For many bands in such a wideband range, for example, phase estimation may be impractical or unnecessary. The practical valuation of phase relationships of a received waveform at very low frequencies typically requires correspondingly large spacings between the transducers. Consequently, the maximum available spacing between microphones may establish a low frequency bound. On the other end, the distance between microphones should not exceed half of the minimum wavelength in order to avoid spatial aliasing. An eight-kilohertz sampling rate, for example, gives a bandwidth from zero to four kilohertz. The wavelength of a four-kHz signal is about 8.5 centimeters, so in this case, the spacing between adjacent microphones should not exceed about four centimeters. The microphone channels may be lowpass filtered in order to remove frequencies that might give rise to spatial aliasing.

It may be desirable to target specific frequency components, or a specific frequency range, across which a speech signal (or other desired signal) may be expected to be directionally coherent. It may be expected that background noise, such as directional noise (e.g., from sources such as automobiles) and/or diffuse noise, will not be directionally coherent over the same range. Speech tends to have low power in the range from four to eight kilohertz, so it may be desirable to forego phase estimation over at least this range. For example, it may be desirable to perform phase estimation and determine directional coherency over a range of from about seven hundred hertz to about two kilohertz.

Accordingly, it may be desirable to configure the detector to calculate phase estimates for fewer than all of the frequency components (e.g., for fewer than all of the frequency samples of an FFT). In one example, the detector calculates phase estimates for the frequency range of 700 Hz to 2000 Hz. For a 128-point FFT of a four-kilohertz-bandwidth signal, the range of 700 to 2000 Hz corresponds roughly to the twenty-three frequency samples from the tenth sample through the thirty-second sample. It may also be desirable to configure the detector to consider only phase differences for frequency components which correspond to multiples of a current pitch estimate for the signal.

A phase-based voice activity detector may be configured to evaluate a directional coherence of the channel pair, based on information from the calculated phase differences. The “directional coherence” of a multichannel signal is defined as the degree to which the various frequency components of the signal arrive from the same direction. For an ideally directionally coherent channel pair, the value of Δφ/ƒ is equal to a constant k for all frequencies, where the value of k is related to the direction of arrival θ and the time delay of arrival τ. The directional coherence of a multichannel signal may be quantified, for example, by rating the estimated direction of arrival for each frequency component (which may also be indicated by a ratio of phase difference and frequency or by a time delay of arrival) according to how well it agrees with a particular direction (e.g., as indicated by a directional masking function), and then combining the rating results for the various frequency components to obtain a coherency measure for the signal.

It may be desirable to produce the coherency measure as a temporally smoothed value (e.g., to calculate the coherency measure using a temporal smoothing function). The contrast of a coherency measure may be expressed as the value of a relation (e.g., the difference or the ratio) between the current value of the coherency measure and an average value of the coherency measure over time (e.g., the mean, mode, or median over the most recent ten, twenty, fifty, or one hundred frames). The average value of a coherency measure may be calculated using a temporal smoothing function. Phase-based VAD techniques, including calculation and application of a measure of directional coherence, are also described in, e.g., U.S. Publ. Pat. Appls. Nos. 2010/0323652 A1 and 2011/038489 A1 (Visser et al.).

A gain-based VAD technique may be configured to indicate presence or absence of voice activity in a segment based on differences between corresponding values of a level or gain measure for each channel. Examples of such a gain measure (which may be calculated in the time domain or in the frequency domain) include total magnitude, average magnitude, RMS amplitude, median magnitude, peak magnitude, total energy, and average energy. It may be desirable to configure the detector to perform a temporal smoothing operation on the gain measures and/or on the calculated differences. A gain-based VAD technique may be configured to produce a segment-level result (e.g., over a desired frequency range) or, alternatively, results for each of a plurality of subbands of each segment.

Gain differences between channels may be used for proximity detection, which may support more aggressive near-field/far-field discrimination, such as better frontal noise suppression (e.g., suppression of an interfering speaker in front of the user). Depending on the distance between microphones, a gain difference between balanced microphone channels will typically occur only if the source is within fifty centimeters or one meter.

A gain-based VAD technique may be configured to detect that a segment is from a desired source in an endfire direction of the microphone array (e.g., to indicate detection of voice activity) when a difference between the gains of the channels is greater than a threshold value. Alternatively, a gain-based VAD technique may be configured to detect that a segment is from a desired source in a broadside direction of the microphone array (e.g., to indicate detection of voice activity) when a difference between the gains of the channels is less than a threshold value. The threshold value may be determined heuristically, and it may be desirable to use different threshold values depending on one or more factors such as signal-to-noise ratio (SNR), noise floor, etc. (e.g., to use a higher threshold value when the SNR is low). Gain-based VAD techniques are also described in, e.g., U.S. Publ. Pat. Appl. No. 2010/0323652 A1 (Visser et al.).

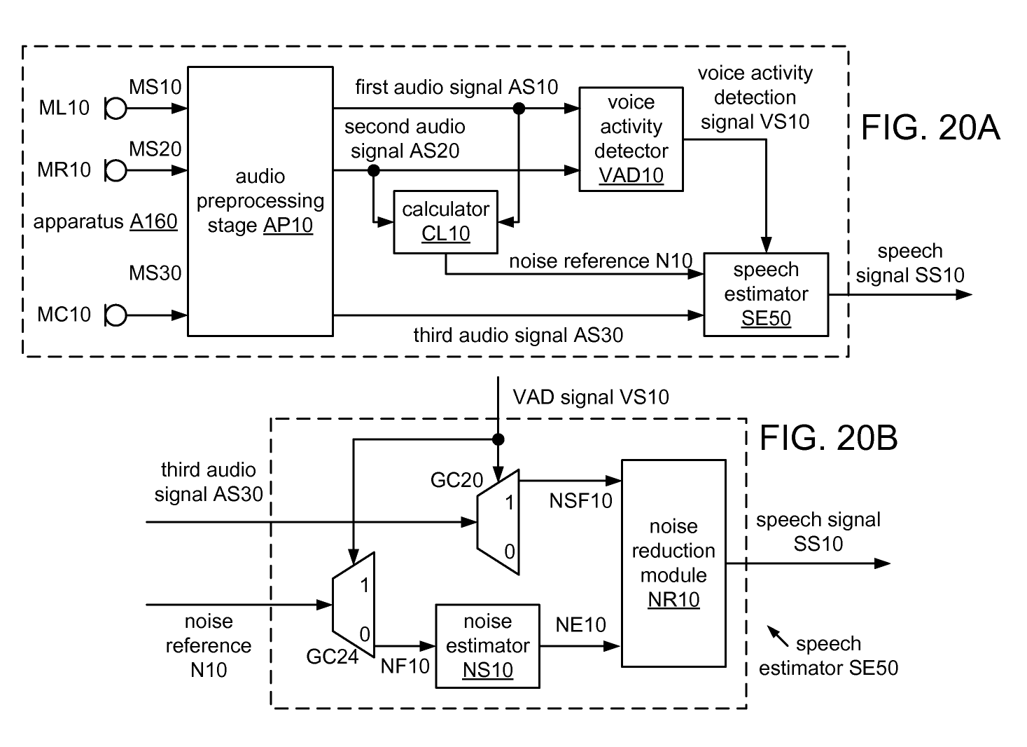

FIG. 20A shows a block diagram of an implementation A160 of apparatus A100 that includes a calculator CL10 that is configured to produce a noise reference N10 based on information from first and second microphone signals MS10, MS20. Calculator CL10 may be configured, for example, to calculate noise reference N10 as a difference between the first and second audio signals AS10, AS20 (e.g., by subtracting signal AS20 from signal AS10, or vice versa). Apparatus A160 also includes an instance of speech estimator SE50 that is arranged to receive third audio signal AS30 and noise reference N10 as inputs, as shown in FIG. 20B, such that selector GC20 is configured to produce the stream of noisy speech frames NSF10 from third audio signal AS30, and selector GC24 is configured to produce the stream of noise frames NF10 from noise reference N10, according to VAD signal VS10.

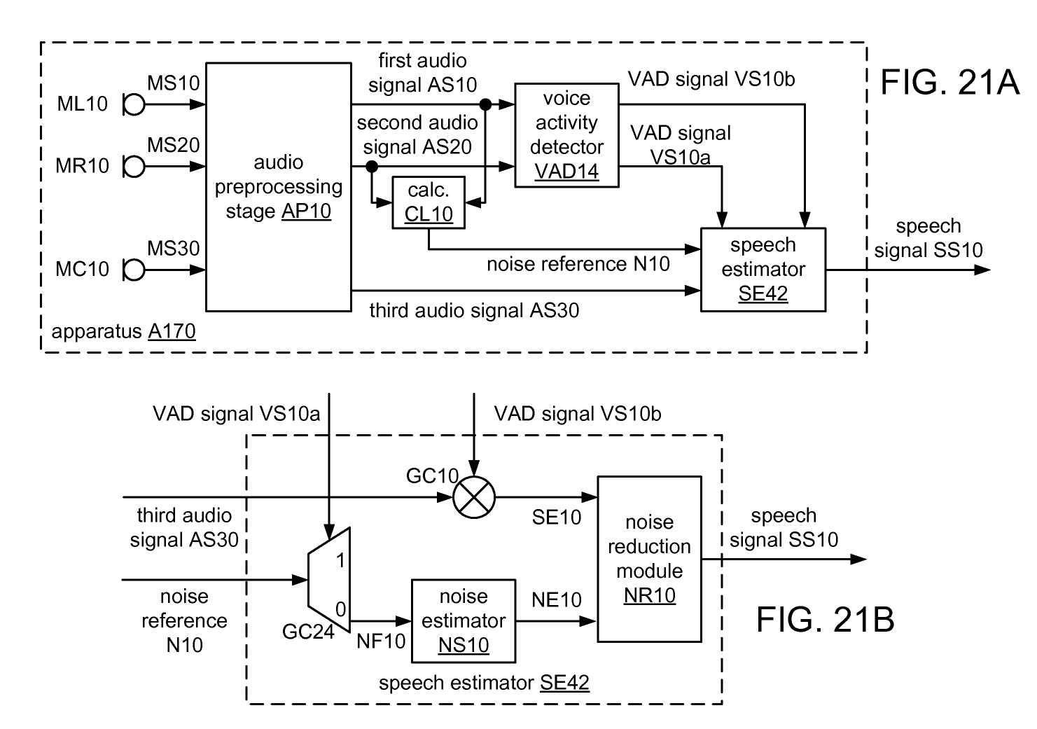

FIG. 21A shows a block diagram of an implementation A170 of apparatus A100 that includes an instance of calculator CL10 as described above. Apparatus A170 also includes an implementation SE42 of speech estimator SE40, as shown in FIG. 21B, that is arranged to receive third audio signal AS30 and noise reference N10 as inputs, such that gain control element GC10 is configured to perform non-binary gain control on third audio signal AS30 according to VAD signal VS10b to produce speech estimate SE10, and selector GC24 is configured to produce the stream of noise frames NF10 from noise reference N10 according to VAD signal VS10a.

Apparatus A100 may also be configured to reproduce an audio signal at each of the user's ears. For example, apparatus A100 may be implemented to include a pair of earbuds (e.g., to be worn as shown in FIG. 3B). FIG. 7B shows a front view of an example of an earbud EB10 that contains left loudspeaker LLS10 and left noise reference microphone ML10. During use, earbud EB10 is worn at the user's left ear to direct an acoustic signal produced by left loudspeaker LLS10 (e.g., from a signal received via cord CD10) into the user's ear canal. It may be desirable for a portion of earbud EB10 which directs the acoustic signal into the user's ear canal to be made of or covered by a resilient material, such as an elastomer (e.g., silicone rubber), such that it may be comfortably worn to form a seal with the user's ear canal.

FIG. 8B shows instances of earbud EB10 and voice microphone MC10 in a corded implementation of apparatus A100. In this example, microphone MC10 is mounted on a semi-rigid cable portion CB10 of cord CD10 at a distance of about three to four centimeters from microphone ML10. Semi-rigid cable CB10 may be configured to be flexible and lightweight yet stiff enough to keep microphone MC10 directed toward the user's mouth during use. FIG. 9B shows a side view of an instance of earbud EB10 in which microphone MC10 is mounted within a strain-relief portion of cord CD10 at the earbud such that microphone MC10 is directed toward the user's mouth during use.

Apparatus A100 may be configured to be worn entirely on the user's head. In such case, apparatus A100 may be configured to produce and transmit speech signal SS10 to a communications device, and to receive a reproduced audio signal (e.g., a far-end communications signal) from the communications device, over a wired or wireless link. Alternatively, apparatus A100 may be configured such that some or all of the processing elements (e.g., voice activity detector VAD10 and/or speech estimator SE10) are located in the communications device (examples of which include but are not limited to a cellular telephone, a smartphone, a tablet computer, and a laptop computer). In either case, signal transfer with the communications device over a wired link may be performed through a multiconductor plug, such as the 3.5-millimeter tip-ring-ring-sleeve (TRRS) plug P10 shown in FIG. 9C.

Apparatus A100 may be configured to include a hook switch SW10 (e.g., on an earbud or earcup) by which the user may control the on- and off-hook status of the communications device (e.g., to initiate, answer, and/or terminate a telephone call). FIG. 9D shows an example in which hook switch SW10 is integrated into cord CD10, and FIG. 9E shows an example of a connector that includes plug P10 and a coaxial plug P20 that is configured to transfer the state of hook switch SW10 to the communications device.

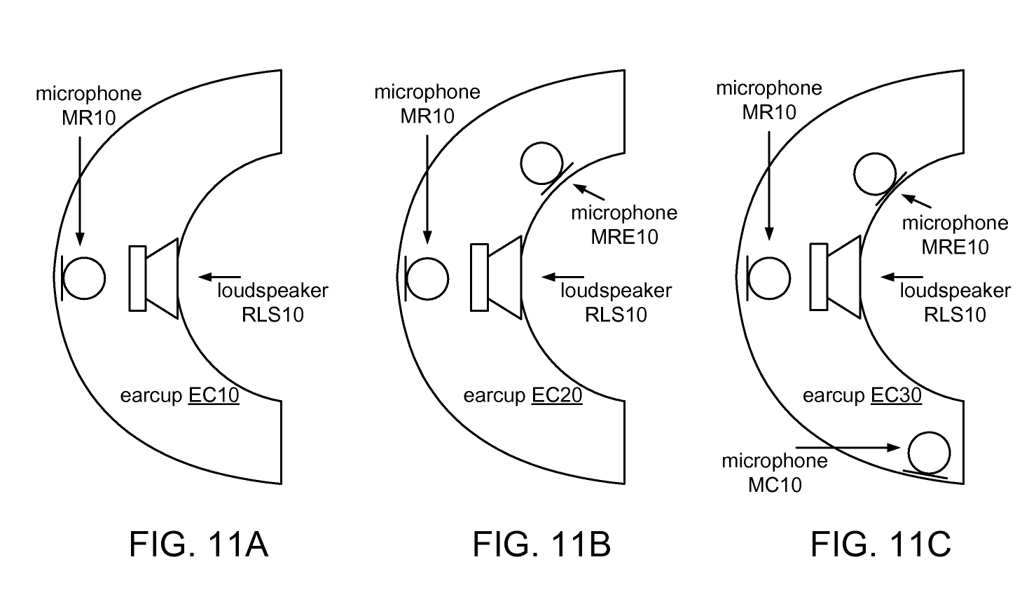

As an alternative to earbuds, apparatus A100 may be implemented to include a pair of earcups, which are typically joined by a band to be worn over the user's head. FIG. 11A shows a cross-sectional view of an earcup EC10 that contains right loudspeaker RLS10, arranged to produce an acoustic signal to the user's ear (e.g., from a signal received wirelessly or via cord CD10), and right noise reference microphone MR10 arranged to receive the environmental noise signal via an acoustic port in the earcup housing. Earcup EC10 may be configured to be supra-aural (i.e., to rest over the user's ear without enclosing it) or circumaural (i.e., to enclose the user's ear).

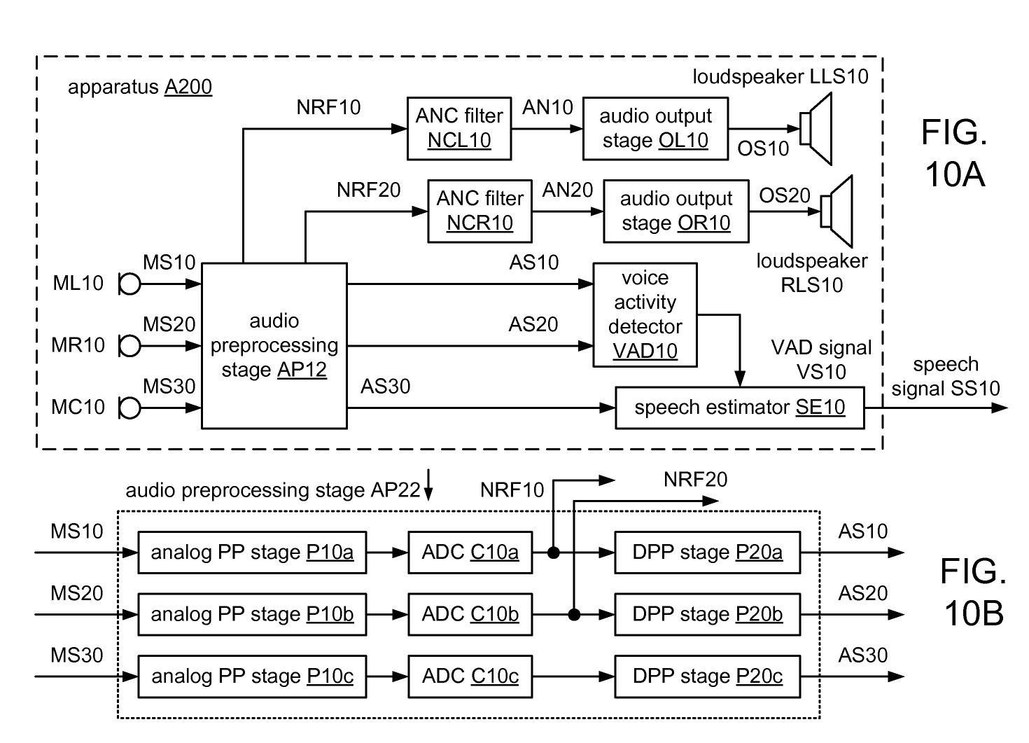

As with conventional active noise cancelling headsets, each of the microphones ML10 and MR10 may be used individually to improve the receiving SNR at the respective ear canal entrance location. FIG. 10A shows a block diagram of such an implementation A200 of apparatus A100. Apparatus A200 includes an ANC filter NCL10 that is configured to produce an antinoise signal AN10 based on information from first microphone signal MS10 and an ANC filter NCR10 that is configured to produce an antinoise signal AN20 based on information from second microphone signal MS20.

Each of ANC filters NCL10, NCR10 may be configured to produce the corresponding antinoise signal AN10, AN20 based on the corresponding audio signal AS10, AS20. It may be desirable, however, for the antinoise processing path to bypass one or more preprocessing operations performed by digital preprocessing stages P20a, P20b (e.g., echo cancellation). Apparatus A200 includes such an implementation AP12 of audio preprocessing stage AP10 that is configured to produce a noise reference NRF10 based on information from first microphone signal MS10 and a noise reference NRF20 based on information from second microphone signal MS20. FIG. 10B shows a block diagram of an implementation AP22 of audio preprocessing stage AP12 in which noise references NRF10, NRF20 bypass the corresponding digital preprocessing stages P20a, P20b. In the example shown in FIG. 10A, ANC filter NCL10 is configured to produce antinoise signal AN10 based on noise reference NRF10, and ANC filter NCR10 is configured to produce antinoise signal AN20 based on noise reference NRF20.

Each of ANC filters NCL10, NCR10 may be configured to produce the corresponding antinoise signal AN10, AN20 according to any desired ANC technique. Such an ANC filter is typically configured to invert the phase of the noise reference signal and may also be configured to equalize the frequency response and/or to match or minimize the delay. Examples of ANC operations that may be performed by ANC filter NCL10 on information from microphone signal ML10 (e.g., on first audio signal AS10 or noise reference NRF10) to produce antinoise signal AN10, and by ANC filter NCR10 on information from microphone signal MR10 (e.g., on second audio signal AS20 or noise reference NRF20) to produce antinoise signal AN20, include a phase-inverting filtering operation, a least mean squares (LMS) filtering operation, a variant or derivative of LMS (e.g., filtered-x LMS, as described in U.S. Pat. Appl. Publ. No. 2006/0069566 (Nadjar et al.) and elsewhere), and a digital virtual earth algorithm (e.g., as described in U.S. Pat. No. 5,105,377 (Ziegler)). Each of ANC filters NCL10, NCR10 may be configured to perform the corresponding ANC operation in the time domain and/or in a transform domain (e.g., a Fourier transform or other frequency domain).

Apparatus A200 includes an audio output stage OL10 that is configured to receive antinoise signal AN10 and to produce a corresponding audio output signal OS10 to drive a left loudspeaker LLS10 configured to be worn at the user's left ear. Apparatus A200 includes an audio output stage OR10 that is configured to receive antinoise signal AN20 and to produce a corresponding audio output signal OS20 to drive a right loudspeaker RLS10 configured to be worn at the user's right ear. Audio output stages OL10, OR10 may be configured to produce audio output signals OS10, OS20 by converting antinoise signals AN10, AN20 from a digital form to an analog form and/or by performing any other desired audio processing operation on the signal (e.g., filtering, amplifying, applying a gain factor to, and/or controlling a level of the signal). Each of audio output stages OL10, OR10 may also be configured to mix the corresponding antinoise signal AN10, AN20 with a reproduced audio signal (e.g., a far-end communications signal) and/or a sidetone signal (e.g., from voice microphone MC10). Audio output stages OL10, OR10 may also be configured to provide impedance matching to the corresponding loudspeaker.

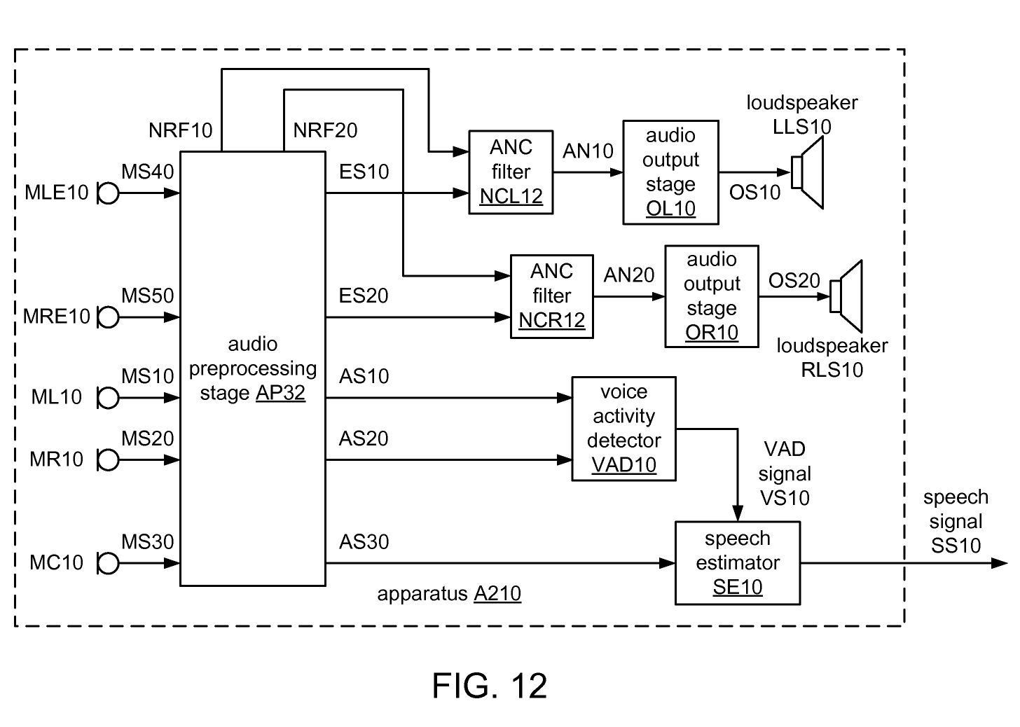

It may be desirable to implement apparatus A100 as an ANC system that includes an error microphone (e.g., a feedback ANC system). FIG. 12 shows a block diagram of such an implementation A210 of apparatus A100. Apparatus A210 includes a left error microphone MLE10 that is configured to be worn at the user's left ear to receive an acoustic error signal and to produce a first error microphone signal MS40 and a right error microphone MLE10 that is configured to be worn at the user's right ear to receive an acoustic error signal and to produce a second error microphone signal MS50. Apparatus A210 also includes an implementation AP32 of audio preprocessing stage AP12 (e.g., of AP22) that is configured to perform one or more preprocessing operations (e.g., analog preprocessing, analog-to-digital conversion) as described herein on each of the microphone signals MS40 and MS50 to produce a corresponding one of a first error signal ES10 and a second error signal ES20.

Apparatus A210 includes an implementation NCL12 of ANC filter NCL10 that is configured to produce an antinoise signal AN10 based on information from first microphone signal MS10 and from first error microphone signal MS40. Apparatus A210 also includes an implementation NCR12 of ANC filter NCR10 that is configured to produce an antinoise signal AN20 based on information from second microphone signal MS20 and from second error microphone signal MS50. Apparatus A210 also includes a left loudspeaker LLS10 that is configured to be worn at the user's left ear and to produce an acoustic signal based on antinoise signal AN10 and a right loudspeaker RLS10 that is configured to be worn at the user's right ear and to produce an acoustic signal based on antinoise signal AN20.

It may be desirable for each of error microphones MLE10, MRE10 to be disposed within the acoustic field generated by the corresponding loudspeaker LLS10, RLS10. For example, it may be desirable for the error microphone to be disposed with the loudspeaker within the earcup of a headphone or an eardrum-directed portion of an earbud. It may be desirable for each of error microphones MLE10, MRE10 to be located closer to the user's ear canal than the corresponding noise reference microphone ML10, MR10. It may also be desirable for the error microphone to be acoustically insulated from the environmental noise. FIG. 7C shows a front view of an implementation EB12 of earbud EB10 that contains left error microphone MLE10. FIG. 11B shows a cross-sectional view of an implementation EC20 of earcup EC10 that contains right error microphone MRE10 arranged to receive the error signal (e.g., via an acoustic port in the earcup housing). It may be desirable to insulate microphones MLE10, MRE10 from receiving mechanical vibrations from the corresponding loudspeaker LLS10, RLS10 through the structure of the earbud or earcup.

FIG. 11C shows a cross-section (e.g., in a horizontal plane or in a vertical plane) of an implementation EC30 of earcup EC20 that also includes voice microphone MC10. In other implementations of earcup EC 10, microphone MC10 may be mounted on a boom or other protrusion that extends from a left or right instance of earcup EC10.

Implementation of apparatus A100 as described herein include implementations that combine features of apparatus A110, A120, A130, A140, A200, and/or A210. For example, apparatus A100 may be implemented to include the features of any two or more of apparatus A110, A120, and A130 as described herein. Such a combination may also be implemented to include the features of apparatus A150 as described herein; or A140, A160, and/or A170 as described herein; and/or the features of apparatus A200 or A210 as described herein. Each such combination is expressly contemplated and hereby disclosed. It is also noted that implementations such as apparatus A130, A140, and A150 may continue to provide noise suppression to a speech signal based on third audio signal AS30 even in a case where the user chooses not to wear noise reference microphone ML10, or microphone ML10 falls from the user's ear. It is further noted that the association herein between first audio signal AS10 and microphone ML10, and the association herein between second audio signal AS20 and microphone MR10, is only for convenience, and that all such cases in which first audio signal AS10 is associated instead with microphone MR10 and second audio signal AS20 is associated instead with microphone MR10 are also contemplated and disclosed.

The processing elements of an implementation of apparatus A100 as described herein (i.e., the elements that are not transducers) may be implemented in hardware and/or in a combination of hardware with software and/or firmware. For example, one or more (possibly all) of these processing elements may be implemented on a processor that is also configured to perform one or more other operations (e.g., vocoding) on speech signal SS10.

The microphone signals (e.g., signals MS10, MS20, MS30) may be routed to a processing chip that is located in a portable audio sensing device for audio recording and/or voice communications applications, such as a telephone handset (e.g., a cellular telephone handset) or smartphone; a wired or wireless headset (e.g., a Bluetooth headset); a handheld audio and/or video recorder; a personal media player configured to record audio and/or video content; a personal digital assistant (PDA) or other handheld computing device; and a notebook computer, laptop computer, netbook computer, tablet computer, or other portable computing device.

The class of portable computing devices currently includes devices having names such as laptop computers, notebook computers, netbook computers, ultra-portable computers, tablet computers, mobile Internet devices, smartbooks, or smartphones. One type of such device has a slate or slab configuration as described above (e.g., a tablet computer that includes a touchscreen display on a top surface, such as the iPad (Apple, Inc., Cupertino, Calif.), Slate (Hewlett-Packard Co., Palo Alto, Calif.), or Streak (Dell Inc., Round Rock, Tex.)) and may also include a slide-out keyboard. Another type of such device that has a top panel which includes a display screen and a bottom panel that may include a keyboard, wherein the two panels may be connected in a clamshell or other hinged relationship.

Other examples of portable audio sensing devices that may be used within an implementation of apparatus A100 as described herein include touchscreen implementations of a telephone handset such as the iPhone (Apple Inc., Cupertino, Calif.), HD2 (HTC, Taiwan, ROC), or CLIQ (Motorola, Inc., Schaumberg, Ill.)).

FIG. 13A shows a block diagram of a communications device D20 that includes an implementation of apparatus A100. Device D20, which may be implemented to include an instance of any of the portable audio sensing devices described herein, includes a chip or chipset CS10 (e.g., a mobile station modem (MSM) chipset) that embodies the processing elements of apparatus A100 (e.g., audio preprocessing stage AP10, voice activity detector VAD10, speech estimator SE10). Chip/chipset CS10 may include one or more processors, which may be configured to execute a software and/or firmware part of apparatus A100 (e.g., as instructions).

Chip/chipset CS10 includes a receiver, which is configured to receive a radio-frequency (RF) communications signal and to decode and reproduce an audio signal encoded within the RF signal, and a transmitter, which is configured to encode an audio signal that is based on speech signal SS10 and to transmit an RF communications signal that describes the encoded audio signal. Such a device may be configured to transmit and receive voice communications data wirelessly via one or more encoding and decoding schemes (also called “codecs”). Examples of such codecs include the Enhanced Variable Rate Codec, as described in the Third Generation Partnership Project 2 (3GPP2) document C.S0014-C, v1.0, entitled “Enhanced Variable Rate Codec, Speech Service Options 3, 68, and 70 for Wideband Spread Spectrum Digital Systems,” February 2007 (available online at www-dot-3gpp-dot-org); the Selectable Mode Vocoder speech codec, as described in the 3GPP2 document C.S0030-0, v3.0, entitled “Selectable Mode Vocoder (SMV) Service Option for Wideband Spread Spectrum Communication Systems,” January 2004 (available online at www-dot-3gpp-dot-org); the Adaptive Multi Rate (AMR) speech codec, as described in the document ETSI TS 126 092 V6.0.0 (European Telecommunications Standards Institute (ETSI), Sophia Antipolis Cedex, FR, December 2004); and the AMR Wideband speech codec, as described in the document ETSI TS126 192 V6.0.0 (ETSI, December 2004).

Device D20 is configured to receive and transmit the RF communications signals via an antenna C30. Device D20 may also include a diplexer and one or more power amplifiers in the path to antenna C30. Chip/chipset CS10 is also configured to receive user input via keypad C10 and to display information via display C20. In this example, device D20 also includes one or more antennas C40 to support Global Positioning System (GPS) location services and/or short-range communications with an external device such as a wireless (e.g., Bluetooth™) headset. In another example, such a communications device is itself a Bluetooth headset and lacks keypad C10, display C20, and antenna C30.

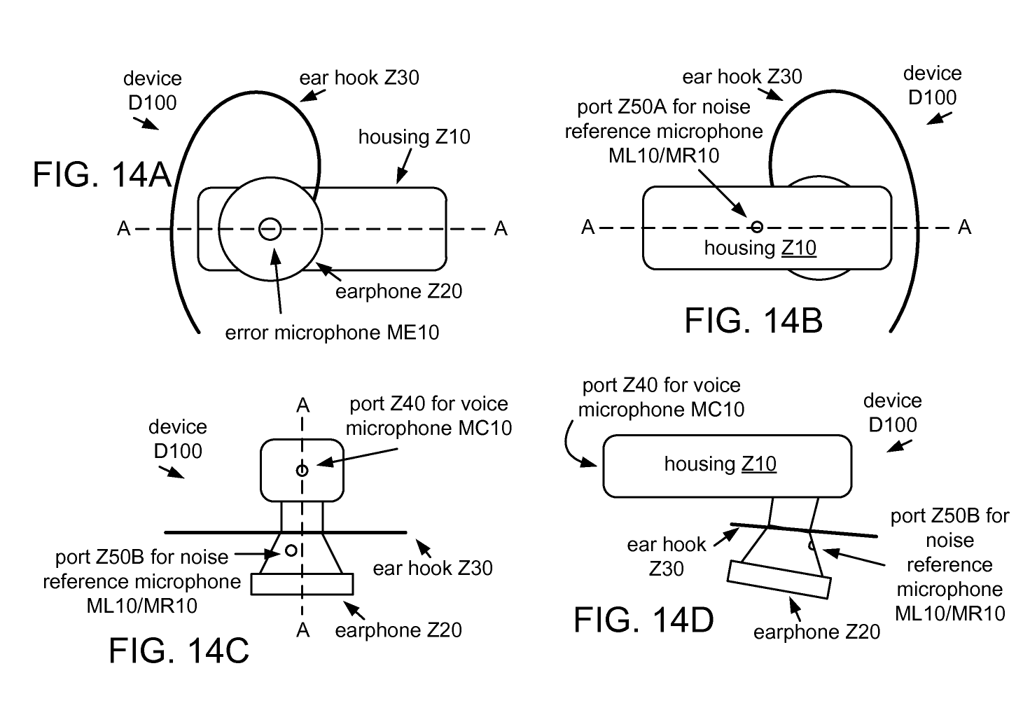

FIGS. 14A to 14D show various views of a headset D100 that may be included within device D20. Device D100 includes a housing Z10 which carries microphones ML10 (or MR10) and MC10 and an earphone Z20 that extends from the housing and encloses a loudspeaker disposed to produce an acoustic signal into the user's ear canal (e.g., loudspeaker LLS10 or RLS10). Such a device may be configured to support half- or full-duplex telephony via wired (e.g., via cord CD10) or wireless (e.g., using a version of the Bluetooth™ protocol as promulgated by the Bluetooth Special Interest Group, Inc., Bellevue, Wash.) communication with a telephone device such as a cellular telephone handset (e.g., a smartphone). In general, the housing of a headset may be rectangular or otherwise elongated as shown in FIGS. 14A, 14B, and 14D (e.g., shaped like a miniboom) or may be more rounded or even circular. The housing may also enclose a battery and a processor and/or other processing circuitry (e.g., a printed circuit board and components mounted thereon) and may include an electrical port (e.g., a mini-Universal Serial Bus (USB) or other port for battery charging) and user interface features such as one or more button switches and/or LEDs. Typically the length of the housing along its major axis is in the range of from one to three inches.

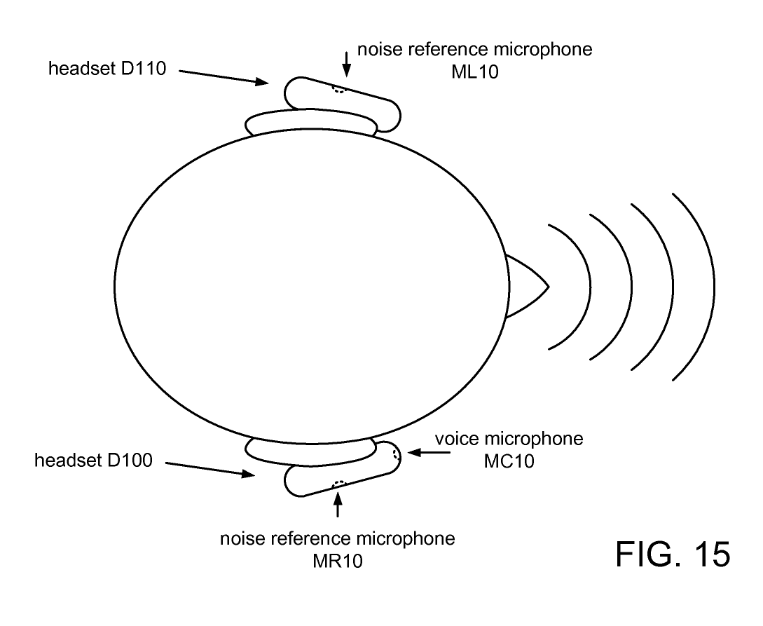

FIG. 15 shows a top view of an example of device D100 in use being worn at the user's right ear. This figure also shows an instance of a headset D110, which also may be included within device D20, in use being worn at the user's left ear. Device D110, which carries noise reference microphone ML10 and may lack a voice microphone, may be configured to communicate with headset D100 and/or with another portable audio sensing device within device D20 over a wired and/or wireless link.

A headset may also include a securing device, such as ear hook Z30, which is typically detachable from the headset. An external ear hook may be reversible, for example, to allow the user to configure the headset for use on either ear. Alternatively, the earphone of a headset may be designed as an internal securing device (e.g., an earplug) which may include a removable earpiece to allow different users to use an earpiece of different size (e.g., diameter) for better fit to the outer portion of the particular user's ear canal.

Typically each microphone of device D100 is mounted within the device behind one or more small holes in the housing that serve as an acoustic port. FIGS. 14B to 14D show the locations of the acoustic port Z40 for voice microphone MC10 and the acoustic port Z50 for the noise reference microphone ML10 (or MR10). FIGS. 13B and 13C show additional candidate locations for noise reference microphones ML10, MR10 and error microphone ME10.

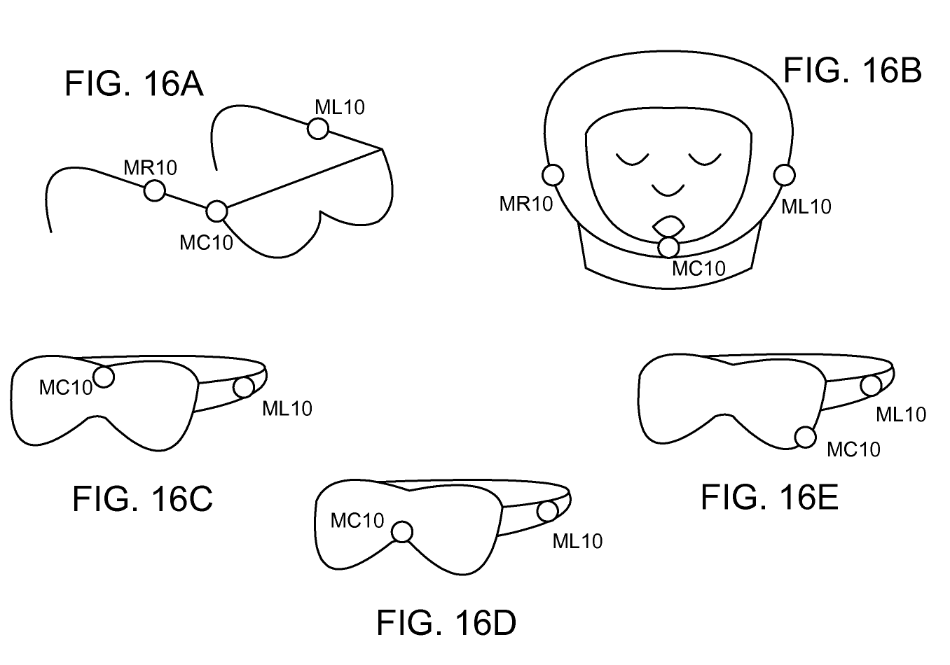

FIGS. 16A-E show additional examples of devices that may be used within an implementation of apparatus A100 as described herein. FIG. 16A shows eyeglasses (e.g., prescription glasses, sunglasses, or safety glasses) having each microphone of noise reference pair ML10, MR10 mounted on a temple and voice microphone MC10 mounted on a temple or the corresponding end piece. FIG. 16B shows a helmet in which voice microphone MC10 is mounted at the user's mouth and each microphone of noise reference pair ML10, MR10 is mounted at a corresponding side of the user's head. FIG. 16C-E show examples of goggles (e.g., ski goggles) in which each microphone of noise reference pair ML10, MR10 is mounted at a corresponding side of the user's head, with each of these examples showing a different corresponding location for voice microphone MC10. Additional examples of placements for voice microphone MC10 during use of a portable audio sensing device that may be used within an implementation of apparatus A100 as described herein include but are not limited to the following: visor or brim of a cap or hat; lapel, breast pocket, or shoulder.

It is expressly disclosed that applicability of systems, methods, and apparatus disclosed herein includes and is not limited to the particular examples disclosed herein and/or shown in FIGS. 2A-3B, 7B, 7C, 8B, 9B, 11A-11C, and 13B to 16E. A further example of a portable computing device that may be used within an implementation of apparatus A100 as described herein is a hands-free car kit. Such a device may be configured to be installed in or on or removably fixed to the dashboard, the windshield, the rear-view mirror, a visor, or another interior surface of a vehicle. Such a device may be configured to transmit and receive voice communications data wirelessly via one or more codecs, such as the examples listed above. Alternatively or additionally, such a device may be configured to support half- or full-duplex telephony via communication with a telephone device such as a cellular telephone handset (e.g., using a version of the Bluetooth™ protocol as described above).

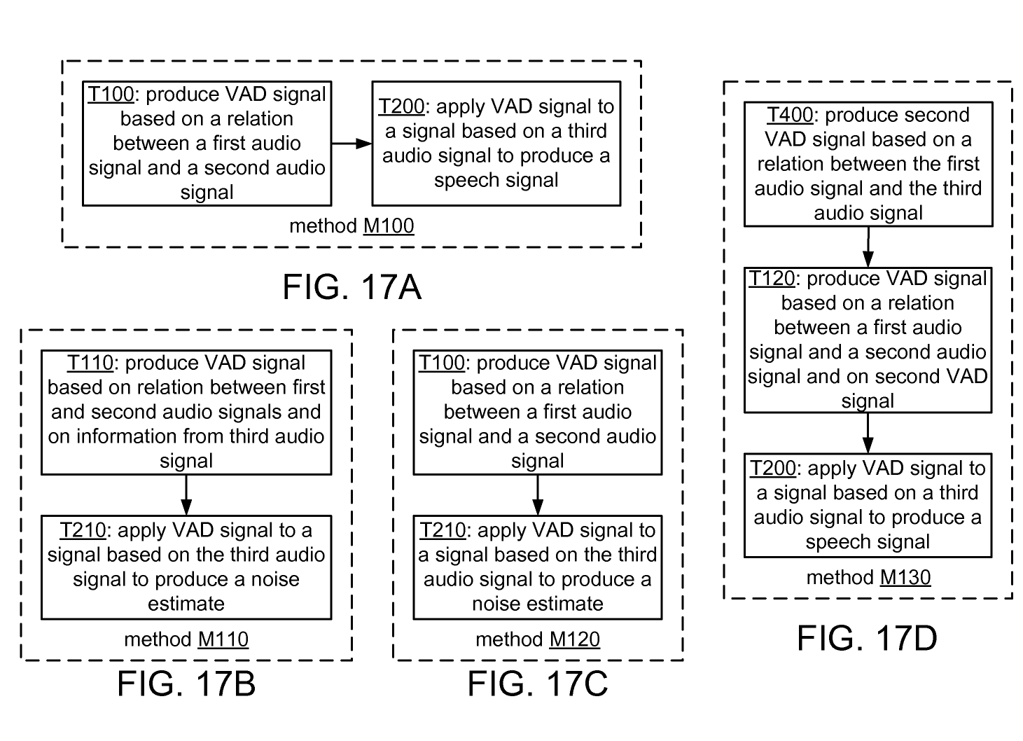

FIG. 17A shows a flowchart of a method M100 according to a general configuration that includes tasks T100 and T200. Task T100 produces a voice activity detection signal that is based on a relation between a first audio signal and a second audio signal (e.g., as described herein with reference to voice activity detector VAD10). The first audio signal is based on a signal produced, in response to a voice of the user, by a first microphone that is located at a lateral side of a user's head. The second audio signal is based on a signal produced, in response to the voice of the user, by a second microphone that is located at the other lateral side of the user's head. Task T200 applies the voice activity detection signal to a third audio signal to produce a speech estimate (e.g., as described herein with reference to speech estimator SE10). The third audio signal is based on a signal produced, in response to the voice of the user, by a third microphone that is different from the first and second microphones, and the third microphone is located in a coronal plane of the user's head that is closer to a central exit point of the user's voice than either of the first and second microphones.

FIG. 17B shows a flowchart of an implementation M110 of method M100 that includes an implementation T110 of task T100. Task T110 produces the VAD signal based on a relation between a first audio signal and a second audio signal and also on information from the third audio signal (e.g., as described herein with reference to voice activity detector VAD12).

FIG. 17C shows a flowchart of an implementation M120 of method M100 that includes an implementation T210 of task T200. Task T210 is configured to apply the VAD signal to a signal based on the third audio signal to produce a noise estimate, wherein the speech signal is based on the noise estimate (e.g., as described herein with reference to speech estimator SE30).

FIG. 17D shows a flowchart of an implementation M130 of method M100 that includes a task T400 and an implementation T120 of task T100. Task T400 produces a second VAD signal based on a relation between the first audio signal and the third audio signal (e.g., as described herein with reference to second voice activity detector VAD20). Task T120 produces the VAD signal based on the relation between the first audio signal and the second audio signal and on the second VAD signal (e.g., as described herein with reference to voice activity detector VAD16).

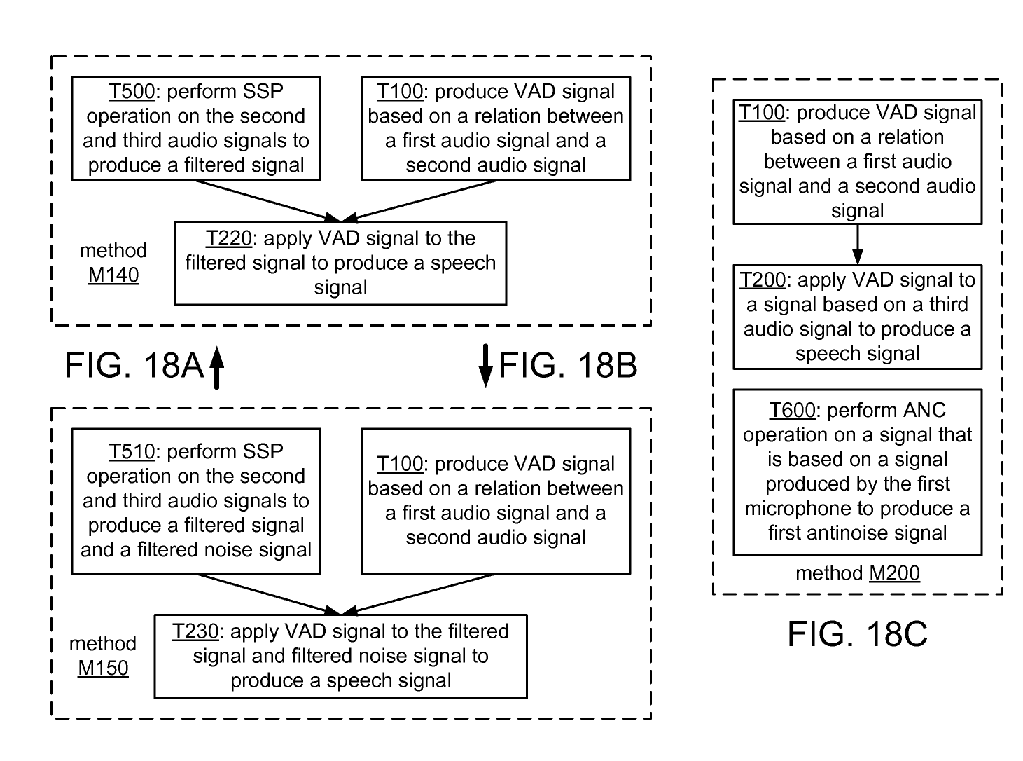

FIG. 18A shows a flowchart of an implementation M140 of method M100 that includes a task T500 and an implementation T220 of task T200. Task T500 performs an SSP operation on the second and third audio signals to produce a filtered signal (e.g., as described herein with reference to SSP filter SSP10). Task T220 applies the VAD signal to the filtered signal to produce the speech signal.

FIG. 18B shows a flowchart of an implementation M150 of method M100 that includes an implementation T510 of task T500 and an implementation T230 of task T200. Task T510 performs an SSP operation on the second and third audio signals to produce a filtered signal and a filtered noise signal (e.g., as described herein with reference to SSP filter SSP12). Task T230 applies the VAD signal to the filtered signal and the filtered noise signal to produce the speech signal (e.g., as described herein with reference to speech estimator SE50).

FIG. 18C shows a flowchart of an implementation M200 of method M100 that includes a task T600. Task T600 performs an ANC operation on a signal that is based on a signal produced by the first microphone to produce a first antinoise signal (e.g., as described herein with reference to ANC filter NCL10).

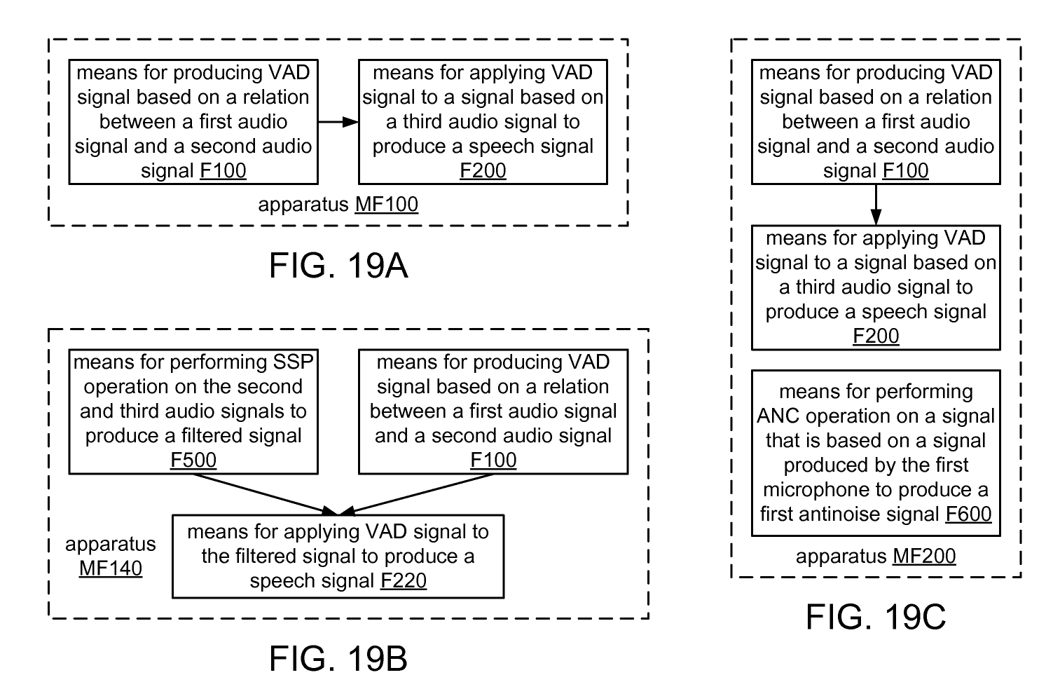

FIG. 19A shows a block diagram of an apparatus MF100 according to a general configuration. Apparatus MF100 includes means F100 for producing a voice activity detection signal that is based on a relation between a first audio signal and a second audio signal (e.g., as described herein with reference to voice activity detector VAD10). The first audio signal is based on a signal produced, in response to a voice of the user, by a first microphone that is located at a lateral side of a user's head. The second audio signal is based on a signal produced, in response to the voice of the user, by a second microphone that is located at the other lateral side of the user's head. Apparatus MF200 also includes means F200 for applying the voice activity detection signal to a third audio signal to produce a speech estimate (e.g., as described herein with reference to speech estimator SE10). The third audio signal is based on a signal produced, in response to the voice of the user, by a third microphone that is different from the first and second microphones, and the third microphone is located in a coronal plane of the user's head that is closer to a central exit point of the user's voice than either of the first and second microphones.

FIG. 19B shows a block diagram of an implementation MF140 of apparatus MF100 that includes means F500 for performing an SSP operation on the second and third audio signals to produce a filtered signal (e.g., as described herein with reference to SSP filter SSP10). Apparatus MF140 also includes an implementation F220 of means F200 that is configured to apply the VAD signal to the filtered signal to produce the speech signal.

FIG. 19C shows a block diagram of an implementation MF200 of apparatus MF100 that includes means F600 for performing an ANC operation on a signal that is based on a signal produced by the first microphone to produce a first antinoise signal (e.g., as described herein with reference to ANC filter NCL10).

The methods and apparatus disclosed herein may be applied generally in any transceiving and/or audio sensing application, especially mobile or otherwise portable instances of such applications. For example, the range of configurations disclosed herein includes communications devices that reside in a wireless telephony communication system configured to employ a code-division multiple-access (CDMA) over-the-air interface. Nevertheless, it would be understood by those skilled in the art that a method and apparatus having features as described herein may reside in any of the various communication systems employing a wide range of technologies known to those of skill in the art, such as systems employing Voice over IP (VoIP) over wired and/or wireless (e.g., CDMA, TDMA, FDMA, and/or TD-SCDMA) transmission channels.

It is expressly contemplated and hereby disclosed that communications devices disclosed herein may be adapted for use in networks that are packet-switched (for example, wired and/or wireless networks arranged to carry audio transmissions according to protocols such as VoIP) and/or circuit-switched. It is also expressly contemplated and hereby disclosed that communications devices disclosed herein may be adapted for use in narrowband coding systems (e.g., systems that encode an audio frequency range of about four or five kilohertz) and/or for use in wideband coding systems (e.g., systems that encode audio frequencies greater than five kilohertz), including whole-band wideband coding systems and split-band wideband coding systems.

The foregoing presentation of the described configurations is provided to enable any person skilled in the art to make or use the methods and other structures disclosed herein. The flowcharts, block diagrams, and other structures shown and described herein are examples only, and other variants of these structures are also within the scope of the disclosure. Various modifications to these configurations are possible, and the generic principles presented herein may be applied to other configurations as well. Thus, the present disclosure is not intended to be limited to the configurations shown above but rather is to be accorded the widest scope consistent with the principles and novel features disclosed in any fashion herein, including in the attached claims as filed, which form a part of the original disclosure.

Those of skill in the art will understand that information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

Important design requirements for implementation of a configuration as disclosed herein may include minimizing processing delay and/or computational complexity (typically measured in millions of instructions per second or MIPS), especially for computation-intensive applications, such as applications for voice communications at sampling rates higher than eight kilohertz (e.g., 12, 16, 44.1, 48, or 192 kHz).

Goals of a multi-microphone processing system as described herein may include achieving ten to twelve dB in overall noise reduction, preserving voice level and color during movement of a desired speaker, obtaining a perception that the noise has been moved into the background instead of an aggressive noise removal, dereverberation of speech, and/or enabling the option of post-processing (e.g., spectral masking and/or another spectral modification operation based on a noise estimate, such as spectral subtraction or Wiener filtering) for more aggressive noise reduction.

The various processing elements of an implementation of an apparatus as disclosed herein (e.g., apparatus A100, A110, A120, A130, A140, A150, A160, A170, A200, A210, MF100, MF104, and MF200) may be embodied in any hardware structure, or any combination of hardware with software and/or firmware, that is deemed suitable for the intended application. For example, such elements may be fabricated as electronic and/or optical devices residing, for example, on the same chip or among two or more chips in a chipset. One example of such a device is a fixed or programmable array of logic elements, such as transistors or logic gates, and any of these elements may be implemented as one or more such arrays. Any two or more, or even all, of these elements may be implemented within the same array or arrays. Such an array or arrays may be implemented within one or more chips (for example, within a chipset including two or more chips).

One or more processing elements of the various implementations of the apparatus disclosed herein (e.g., apparatus A100, A110, A120, A130, A140, A150, A160, A170, A200, A210, MF100, MF140, and MF200) may also be implemented in part as one or more sets of instructions arranged to execute on one or more fixed or programmable arrays of logic elements, such as microprocessors, embedded processors, IP cores, digital signal processors, FPGAs (field-programmable gate arrays), ASSPs (application-specific standard products), and ASICs (application-specific integrated circuits). Any of the various elements of an implementation of an apparatus as disclosed herein may also be embodied as one or more computers (e.g., machines including one or more arrays programmed to execute one or more sets or sequences of instructions, also called “processors”), and any two or more, or even all, of these elements may be implemented within the same such computer or computers.

A processor or other means for processing as disclosed herein may be fabricated as one or more electronic and/or optical devices residing, for example, on the same chip or among two or more chips in a chipset. One example of such a device is a fixed or programmable array of logic elements, such as transistors or logic gates, and any of these elements may be implemented as one or more such arrays. Such an array or arrays may be implemented within one or more chips (for example, within a chipset including two or more chips). Examples of such arrays include fixed or programmable arrays of logic elements, such as microprocessors, embedded processors, IP cores, DSPs, FPGAs, ASSPs, and ASICs. A processor or other means for processing as disclosed herein may also be embodied as one or more computers (e.g., machines including one or more arrays programmed to execute one or more sets or sequences of instructions) or other processors. It is possible for a processor as described herein to be used to perform tasks or execute other sets of instructions that are not directly related to a procedure of an implementation of method M100, such as a task relating to another operation of a device or system in which the processor is embedded (e.g., an audio sensing device). It is also possible for part of a method as disclosed herein to be performed by a processor of the audio sensing device (e.g., task T200) and for another part of the method to be performed under the control of one or more other processors (e.g., task T600).

Those of skill will appreciate that the various illustrative modules, logical blocks, circuits, and tests and other operations described in connection with the configurations disclosed herein may be implemented as electronic hardware, computer software, or combinations of both. Such modules, logical blocks, circuits, and operations may be implemented or performed with a general purpose processor, a digital signal processor (DSP), an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in a non-transitory storage medium such as RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, or a CD-ROM; or in any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

It is noted that the various methods disclosed herein (e.g., methods M100, M110, M120, M130, M140, M150, and M200) may be performed by an array of logic elements such as a processor, and that the various elements of an apparatus as described herein may be implemented in part as modules designed to execute on such an array. As used herein, the term “module” or “sub-module” can refer to any method, apparatus, device, unit or computer-readable data storage medium that includes computer instructions (e.g., logical expressions) in software, hardware or firmware form. It is to be understood that multiple modules or systems can be combined into one module or system and one module or system can be separated into multiple modules or systems to perform the same functions. When implemented in software or other computer-executable instructions, the elements of a process are essentially the code segments to perform the related tasks, such as with routines, programs, objects, components, data structures, and the like. The term “software” should be understood to include source code, assembly language code, machine code, binary code, firmware, macrocode, microcode, any one or more sets or sequences of instructions executable by an array of logic elements, and any combination of such examples. The program or code segments can be stored in a processor-readable storage medium or transmitted by a computer data signal embodied in a carrier wave over a transmission medium or communication link.

The implementations of methods, schemes, and techniques disclosed herein may also be tangibly embodied (for example, in tangible, computer-readable features of one or more computer-readable storage media as listed herein) as one or more sets of instructions executable by a machine including an array of logic elements (e.g., a processor, microprocessor, microcontroller, or other finite state machine). The term “computer-readable medium” may include any medium that can store or transfer information, including volatile, nonvolatile, removable, and non-removable storage media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk, a fiber optic medium, a radio frequency (RF) link, or any other medium which can be used to store the desired information and which can be accessed. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such embodiments.

Each of the tasks of the methods described herein may be embodied directly in hardware, in a software module executed by a processor, or in a combination of the two. In a typical application of an implementation of a method as disclosed herein, an array of logic elements (e.g., logic gates) is configured to perform one, more than one, or even all of the various tasks of the method. One or more (possibly all) of the tasks may also be implemented as code (e.g., one or more sets of instructions), embodied in a computer program product (e.g., one or more data storage media, such as disks, flash or other nonvolatile memory cards, semiconductor memory chips, etc.), that is readable and/or executable by a machine (e.g., a computer) including an array of logic elements (e.g., a processor, microprocessor, microcontroller, or other finite state machine). The tasks of an implementation of a method as disclosed herein may also be performed by more than one such array or machine. In these or other implementations, the tasks may be performed within a device for wireless communications such as a cellular telephone or other device having such communications capability. Such a device may be configured to communicate with circuit-switched and/or packet-switched networks (e.g., using one or more protocols such as VoIP). For example, such a device may include RF circuitry configured to receive and/or transmit encoded frames.

It is expressly disclosed that the various methods disclosed herein may be performed by a portable communications device (e.g., a handset, headset, or portable digital assistant (PDA)), and that the various apparatus described herein may be included within such a device. A typical real-time (e.g., online) application is a telephone conversation conducted using such a mobile device.

In one or more exemplary embodiments, the operations described herein may be implemented in hardware, software, firmware, or any combination thereof. If implemented in software, such operations may be stored on or transmitted over a computer-readable medium as one or more instructions or code. The term “computer-readable media” includes both computer-readable storage media and communication (e.g., transmission) media. By way of example, and not limitation, computer-readable storage media can comprise an array of storage elements, such as semiconductor memory (which may include without limitation dynamic or static RAM, ROM, EEPROM, and/or flash RAM), or ferroelectric, magnetoresistive, ovonic, polymeric, or phase-change memory; CD-ROM or other optical disk storage; and/or magnetic disk storage or other magnetic storage devices. Such storage media may store information in the form of instructions or data structures that can be accessed by a computer. Communication media can comprise any medium that can be used to carry desired program code in the form of instructions or data structures and that can be accessed by a computer, including any medium that facilitates transfer of a computer program from one place to another. Also, any connection is properly termed a computer-readable medium. For example, if the software is transmitted from a website, server, or other remote source using a coaxial cable, fiber optic cable, twisted pair, digital subscriber line (DSL), or wireless technology such as infrared, radio, and/or microwave, then the coaxial cable, fiber optic cable, twisted pair, DSL, or wireless technology such as infrared, radio, and/or microwave are included in the definition of medium. Disk and disc, as used herein, includes compact disc (CD), laser disc, optical disc, digital versatile disc (DVD), floppy disk and Blu-ray Disc™ (Blu-Ray Disc Association, Universal City, Calif.), where disks usually reproduce data magnetically, while discs reproduce data optically with lasers. Combinations of the above should also be included within the scope of computer-readable media.

An acoustic signal processing apparatus as described herein may be incorporated into an electronic device that accepts speech input in order to control certain operations, or may otherwise benefit from separation of desired noises from background noises, such as communications devices. Many applications may benefit from enhancing or separating clear desired sound from background sounds originating from multiple directions. Such applications may include human-machine interfaces in electronic or computing devices which incorporate capabilities such as voice recognition and detection, speech enhancement and separation, voice-activated control, and the like. It may be desirable to implement such an acoustic signal processing apparatus to be suitable in devices that only provide limited processing capabilities.

The elements of the various implementations of the modules, elements, and devices described herein may be fabricated as electronic and/or optical devices residing, for example, on the same chip or among two or more chips in a chipset. One example of such a device is a fixed or programmable array of logic elements, such as transistors or gates. One or more elements of the various implementations of the apparatus described herein may also be implemented in whole or in part as one or more sets of instructions arranged to execute on one or more fixed or programmable arrays of logic elements such as microprocessors, embedded processors, IP cores, digital signal processors, FPGAs, ASSPs, and ASICs.

It is possible for one or more elements of an implementation of an apparatus as described herein to be used to perform tasks or execute other sets of instructions that are not directly related to an operation of the apparatus, such as a task relating to another operation of a device or system in which the apparatus is embedded. It is also possible for one or more elements of an implementation of such an apparatus to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

What is claimed is:

1. A method of signal processing, said method comprising:
producing a voice activity detection signal that is based on a relation between a first audio signal and a second audio signal; and
applying the voice activity detection signal to a signal that is based on a third audio signal to produce a speech signal,
wherein the first audio signal is based on a signal produced (A) by a first microphone that is located at a lateral side of a user's head and (B) in response to a voice of the user, and
wherein the second audio signal is based on a signal produced, in response to the voice of the user, by a second microphone that is located at the other lateral side of the user's head, and
wherein the third audio signal is based on a signal produced, in response to the voice of the user, by a third microphone that is different from the first and second microphones, and
wherein the third microphone is located in a coronal plane of the user's head that is closer to a central exit point of the user's voice than either of the first and second microphones.

2. The method according to claim 1, wherein said applying the voice activity detection signal comprises applying the voice activity detection signal to the signal that is based on the third audio signal to produce a noise estimate, and
wherein said speech signal is based on the noise estimate.

3. The method according to claim 2, wherein said applying the voice activity detection signal comprises:
applying the voice activity detection signal to the signal that is based on the third audio signal to produce a speech estimate; and
performing a noise reduction operation, based on the noise estimate, on the speech estimate to produce the speech signal.

4. The method according to claim 1, wherein said method comprises calculating a difference between (A) a signal that is based on a signal produced by the first microphone and (B) a signal that is based on a signal produced by the second microphone to produce a noise reference, and
wherein said speech signal is based on the noise reference.

5. The method according to claim 1, wherein said method comprises performing a spatially selective processing operation, based on the second and third audio signals, to produce a speech estimate, and
wherein said signal that is based on a third audio signal is the speech estimate.

6. The method according to claim 1, wherein said producing the voice activity detection signal comprises calculating a cross-correlation between the first and second audio signals.

7. The method according to claim 1, wherein said method comprises producing a second voice activity detection signal that is based on a relation between the second audio signal and the third audio signal, and
wherein said voice activity detection signal is based on the second voice activity detection signal.

8. The method according to claim 1, wherein said method comprises performing a spatially selective processing operation on the second and third audio signals to produce a filtered signal, and
wherein said signal that is based on a third audio signal is the filtered signal.

9. The method according to claim 1, wherein said method comprises:
performing a first active noise cancellation operation on a signal that is based on a signal produced by the first microphone to produce a first antinoise signal; and
driving a loudspeaker located at the lateral side of the user's head to produce an acoustic signal that is based on the first antinoise signal.

10. The method according to claim 9, wherein said antinoise signal is based on information from an acoustic error signal produced by an error microphone located at the lateral side of the user's head.

11. An apparatus for signal processing, said apparatus comprising:
means for producing a voice activity detection signal that is based on a relation between a first audio signal and a second audio signal; and
means for applying the voice activity detection signal to a signal that is based on a third audio signal to produce a speech signal,
wherein the first audio signal is based on a signal produced (A) by a first microphone that is located at a lateral side of a user's head and (B) in response to a voice of the user, and
wherein the second audio signal is based on a signal produced, in response to the voice of the user, by a second microphone that is located at the other lateral side of the user's head, and
wherein the third audio signal is based on a signal produced, in response to the voice of the user, by a third microphone that is different from the first and second microphones, and
wherein the third microphone is located in a coronal plane of the user's head that is closer to a central exit point of the user's voice than either of the first and second microphones.

12. The apparatus according to claim 11, wherein said means for applying the voice activity detection signal is configured to apply the voice activity detection signal to the signal that is based on the third audio signal to produce a noise estimate, and wherein said speech signal is based on the noise estimate.

13. The apparatus according to claim 12, wherein said means for applying the voice activity detection signal comprises:
means for applying the voice activity detection signal to the signal that is based on the third audio signal to produce a speech estimate; and
means for performing a noise reduction operation, based on the noise estimate, on the speech estimate to produce the speech signal.

14. The apparatus according to claim 11, wherein said apparatus comprises means for calculating a difference between (A) a signal that is based on a signal produced by the first microphone and (B) a signal that is based on a signal produced by the second microphone to produce a noise reference, and
wherein said speech signal is based on the noise reference.

15. The apparatus according to claim 11, wherein said apparatus comprises means for performing a spatially selective processing operation, based on the second and third audio signals, to produce a speech estimate, and
wherein said signal that is based on a third audio signal is the speech estimate.

16. The apparatus according to claim 11, wherein said means for producing the voice activity detection signal comprises means for calculating a cross-correlation between the first and second audio signals.

17. The apparatus according to claim 11, wherein said apparatus comprises means for producing a second voice activity detection signal that is based on a relation between the second audio signal and the third audio signal, and
wherein said voice activity detection signal is based on the second voice activity detection signal.

18. The apparatus according to claim 11, wherein said apparatus comprises means for performing a spatially selective processing operation on the second and third audio signals to produce a filtered signal, and
wherein said signal that is based on a third audio signal is the filtered signal.

19. The apparatus according to claim 11, wherein said apparatus comprises:
means for performing a first active noise cancellation operation on a signal that is based on a signal produced by the first microphone to produce a first antinoise signal; and
means for driving a loudspeaker located at the lateral side of the user's head to produce an acoustic signal that is based on the first antinoise signal.

20. The apparatus according to claim 19, wherein said antinoise signal is based on information from an acoustic error signal produced by an error microphone located at the lateral side of the user's head.

21. An apparatus for signal processing, said apparatus comprising:
a first microphone configured to be located during a use of the apparatus at a lateral side of a user's head;
a second microphone configured to be located during the use of the apparatus at the other lateral side of the user's head;
a third microphone configured to be located during the use of the apparatus in a coronal plane of the user's head that is closer to a central exit point of a voice of the user than either of the first and second microphones;
a voice activity detector configured to produce a voice activity detection signal that is based on a relation between a first audio signal and a second audio signal; and
a speech estimator configured to apply the voice activity detection signal to a signal that is based on a third audio signal to produce a speech estimate,
wherein the first audio signal is based on a signal produced, in response to the voice of the user, by the first microphone during the use of the apparatus, and
wherein the second audio signal is based on a signal produced, in response to the voice of the user, by the second microphone during the use of the apparatus, and
wherein the third audio signal is based on a signal produced, in response to the voice of the user, by the third microphone during the use of the apparatus.

22. The apparatus according to claim 21, wherein said speech estimator is configured to apply the voice activity detection signal to the signal that is based on the third audio signal to produce a noise estimate, and
wherein said speech signal is based on the noise estimate.

23. The apparatus according to claim 22, wherein said speech estimator comprises:
a gain control element configured to apply the voice activity detection signal to the signal that is based on the third audio signal to produce a speech estimate; and
a noise reduction module configured to perform a noise reduction operation, based on the noise estimate, on the speech estimate to produce the speech signal.

24. The apparatus according to claim 21, wherein said apparatus comprises a calculator configured to calculate a difference between (A) a signal that is based on a signal produced by the first microphone and (B) a signal that is based on a signal produced by the second microphone to produce a noise reference, and
wherein said speech signal is based on the noise reference.

25. The apparatus according to claim 21, wherein said apparatus comprises a filter configured to perform a spatially selective processing operation, based on the second and third audio signals, to produce a speech estimate, and
wherein said signal that is based on a third audio signal is the speech estimate.

26. The apparatus according to claim 21, wherein said voice activity detector is configured to produce the voice activity detection signal based on a result of cross-correlating the first and second audio signals.

27. The apparatus according to claim 21, wherein said apparatus comprises a second voice activity detector configured to produce a second voice activity detection signal that is based on a relation between the second audio signal and the third audio signal, and
wherein said voice activity detection signal is based on the second voice activity detection signal.

28. The apparatus according to claim 21, wherein said apparatus comprises a filter configured to perform a spatially selective processing operation on the second and third audio signals to produce a filtered signal, and
wherein said signal that is based on a third audio signal is the filtered signal.

29. The apparatus according to claim 21, wherein said apparatus comprises:
a first active noise cancellation filter configured to perform an active noise cancellation operation on a signal that is based on a signal produced by the first microphone to produce a first antinoise signal; and
a loudspeaker configured to be located during the use of the apparatus at the lateral side of the user's head and to produce an acoustic signal that is based on the first antinoise signal.

30. The apparatus according to claim 29, wherein said apparatus includes an error microphone configured to be located during the use of the apparatus at the lateral side of the user's head and closer to an ear canal of the lateral side of the user than the first microphone, and
wherein said antinoise signal is based on information from an acoustic error signal produced by the error microphone.

31. A non-transitory computer-readable storage medium having tangible features that cause a machine reading the features to:
produce a voice activity detection signal that is based on a relation between a first audio signal and a second audio signal; and
apply the voice activity detection signal to a signal that is based on a third audio signal to produce a speech signal,
wherein the first audio signal is based on a signal produced (A) by a first microphone that is located at a lateral side of a user's head and (B) in response to a voice of the user, and
wherein the second audio signal is based on a signal produced, in response to the voice of the user, by a second microphone that is located at the other lateral side of the user's head, and
wherein the third audio signal is based on a signal produced, in response to the voice of the user, by a third microphone that is different from the first and second microphones, and
wherein the third microphone is located in a coronal plane of the user's head that is closer to a central exit point of the user's voice than either of the first and second microphones.

32. The computer-readable storage medium according to claim 31, wherein said applying the voice activity detection signal comprises applying the voice activity detection signal to the signal that is based on the third audio signal to produce a noise estimate, and
wherein said speech signal is based on the noise estimate.

33. The computer-readable storage medium according to claim 32, wherein said
applying the voice activity detection signal comprises:
applying the voice activity detection signal to the signal that is based on the third audio signal to produce a speech estimate; and
performing a noise reduction operation, based on the noise estimate, on the speech estimate to produce the speech signal.

34. The computer-readable storage medium according to claim 31, wherein said medium has tangible features that cause a machine reading the features to calculate a difference between (A) a signal that is based on a signal produced by the first microphone and (B) a signal that is based on a signal produced by the second microphone to produce a noise reference, and
wherein said speech signal is based on the noise reference.

35. The computer-readable storage medium according to claim 31, wherein said medium has tangible features that cause a machine reading the features to perform a spatially selective processing operation, based on the second and third audio signals, to produce a speech estimate, and
wherein said signal that is based on a third audio signal is the speech estimate.

36. The computer-readable storage medium according to claim 31, wherein said producing the voice activity detection signal comprises calculating a cross-correlation between the first and second audio signals.

37. The computer-readable storage medium according to claim 31, wherein said medium has tangible features that cause a machine reading the features to produce a second voice activity detection signal that is based on a relation between the second audio signal and the third audio signal, and
wherein said voice activity detection signal is based on the second voice activity detection signal.

38. The computer-readable storage medium according to claim 31, wherein said medium has tangible features that cause a machine reading the features to perform a spatially selective processing operation on the second and third audio signals to produce a filtered signal, and
wherein said signal that is based on a third audio signal is the filtered signal.

39. The computer-readable storage medium according to claim 31, wherein said medium has tangible features that cause a machine reading the features to:
perform a first active noise cancellation operation on a signal that is based on a signal produced by the first microphone to produce a first antinoise signal; and
drive a loudspeaker located at the lateral side of the user's head to produce an acoustic signal that is based on the first antinoise signal.

40. The computer-readable storage medium according to claim 39, wherein said antinoise signal is based on information from an acoustic error signal produced by an error microphone located at the lateral side of the user's head.
